(19) United States
(12) Patent Application Publication
(10) Pub. No.: US 2016/0065362 A1
(43) Pub. Date: Mar. 3, 2016

(54) SECURING PEER-TO-PEER AND GROUP COMMUNICATIONS

(71) Applicant: INTERDIGITAL PATENT HOLDINGS, INC., Wilmington, DE (US)

(72) Inventors: Vinod K. CHOYI, Norristown, PA (US); Samian KAUR, Plymouth Meeting, PA (US); Alec BRUSILOVSKY, Downingtown, PA (US); Yogendra C. SHAH, Exton, PA (US)

(21) Appl. No.: 14/781,723

(22) PCT Filed: Apr. 4, 2014
(86) PCT No.: PCT/US2014/032960

§ 371 Date: Oct. 1, 2015

Related U.S. Application Data
(60) Provisional application No. 61/809,067, filed on Apr. 5, 2013.

(51) Int. Cl. H04L 9/08; H04L 29/06; H04W 12/04

(52) U.S. Cl. CPC H04L 9/083; H04L 9/0847; H04W 12/04; H04L 63/065

(57) ABSTRACT

Systems, methods and apparatus embodiments are described herein for leveraging security associations to enhance security of proximity services. Existing security associations are leveraged to create security associations that are used by proximity services. For example, existing keys may be leveraged to derive new keys that may be used to secure peer-to-peer communications.

### CROSS REFERENCE TO RELATED APPLICATIONS

This Application claims the benefit of U.S. Provisional Patent Application Ser. No. 61/809,067 filed Apr. 5, 2013 and U.S. Provisional Patent Application Ser. No. 61/898,763 filed Nov. 1, 2013, the disclosures of which are hereby incorporated by reference as if set forth in their entireties herein.

### BACKGROUND

Device-to-Device (D2D) communication, which can also be referred to as peer-to-peer (P2P) communication in some cases, can be implemented via a direct path or a local path. In a direct path D2D communication between two devices, the physical communication is direct between the two devices such that there is no intermediary between the two devices. In a local path D2D communication between two example devices, the communication can be through a node, such as an eNodeB (eNB) for example, to which both devices are connected. D2D communication may be utilized to implement proximity services (ProSe) of 3GPP, for example. Proximity services generally refer to services, applications, communications, or the like that can be invoked when devices are within a physical proximity of each other. Example proximity services include public safety applications, social applications, or the like. Proximity services may also be used by two devices that are not physically close to one another. For example, two devices that are not in physical proximity with each other can use proximity services by using D2D communication with other devices that act as a relay node between the two devices. Proximity services may also be referred to as proximity-based services, without limitation.

Different implementations of proximity services impose different requirements on a communication system. Existing approaches to implementing proximity services lack security, such as integrity and confidentiality of the proximity service communications for example. Further, privacy may be lacking during discovery of proximity services during P2P and group communications.

### SUMMARY

In the various example embodiments described herein, security of proximity services (ProSe) is enabled. In an example embodiment, existing security associations at the network layers are leveraged to create ProSe network-level security associations. In accordance with another example embodiment, existing security associations at the application layer are leveraged to create ProSe network-layer associations. Similarly, existing security associations at the application layer may be leveraged to create ProSe application layer-associations. In yet another example embodiment, security associations at the network layer are leveraged to create ProSe Application-layer associations.

In one embodiment, one or more user equipments (UEs), for instance a first UE and a second UE, each have a pre-established security association with a network entity. For example, the network entity may be an eNodeB (eNB) or a mobile management entity (MME). A proximity service security function (PSSF) may obtain a first key that is associated with the pre-established security association between the first UE and the network entity, and the PSSF may obtain a second key that is associated with the pre-established security association between the second UE and the network entity. In accordance with the example, the PSSF receives notification indicating that the first UE and the second UE desire to engage in proximity communications. The PSSF may derive, based on the first key and second key, first and second intermediate keys that can be used by the first UE and second UE, respectively, to derive a common shared key for securing proximity communications between the first UE and the second UE.

### BRIEF DESCRIPTION OF THE DRAWINGS

A more detailed understanding may be had from the following description, given by way of example in conjunction with the accompanying drawings wherein:

FIG. 1 is a system diagram of an example proximity service radio-level architecture;

FIG. 2 is a block diagram of entities involved in securing proximity service communications according to an example embodiment;

FIG. 3 is a diagram of a group communications implementation;

FIG. 4 is a block diagram of example security functions;

FIG. 5 is a block diagram of example security types;

FIG. 6 is a block diagram of an example proximity service access stratum (AS) (PrAS) architecture according to an example embodiment;

FIG. 7A is a flow diagram for key generation and distribution according to an example embodiment in which a proximity service security function (PSSF) is implemented on an eNB;

FIG. 7B is a flow diagram for key generation and distribution according to another example embodiment in which the PSSF is implemented on a mobile management entity (MME);

FIG. 8 is a flow diagram for an example method of discovery;

FIG. 9 is a flow diagram for authenticated identity-based encryption (IBE) key exchange according to an example embodiment;

FIG. 10A is a flow diagram for network-based group-key derivation according to an example embodiment;

FIG. 10B is a flow diagram for re-keying according to an example embodiment in which a member joins the group and another member leaves the group;

FIG. 11A is a flow diagram for identity list processing according to an example embodiment;

FIG. 11B is a flow diagram for a process of authentication based on pre-shared keys according to an example embodiment;

FIG. 11C is a flow diagram for a process of authentication based on pre-shared keys and other parameters according to an example embodiment;

FIG. 11D is a flow diagram for a process of authentication based a digital signature according to an example embodiment;

FIG. 12A is a system diagram of an example communications system in which one or more disclosed embodiments may be implemented;

FIG. 12B is a system diagram of an example wireless transmit/receive unit (WTRU) that may be used within the communications system illustrated in FIG. 12A; and

FIG. 12C is a system diagram of an example radio access network and an example core network that may be used within the communications system illustrated in FIG. 12A.

### DETAILED DESCRIPTION OF ILLUSTRATIVE EMBODIMENTS

The ensuing detailed description is provided to illustrate example embodiments and is not intended to limit the scope, applicability, or configuration of the invention. Various changes may be made in the function and arrangement of elements and steps without departing from the spirit and scope of the invention.

As described above, current techniques are lacking for securing proximity service communications such that the communications are confidential and trustworthy. Various embodiments described herein enable secure D2D communications. Further, various embodiments described herein may be implemented in various example scenarios (use cases) that use proximity services. In an example of a social application of proximity services, D2D users are able to discover and be discovered by other D2D users that belong to a user group (e.g., a friend list). Discovered users may communicate via a social network application over a D2D link. Discovery may be performed without location information of the user equipment (UE). In another example social application of proximity services, D2D users may be publicly discovered by another D2D user without granting prior permission to be discovered. Alternatively, in a restricted discovery mode, only authorized D2D users may be able to discover other D2D users of interest. In yet another example scenario, D2D users that belong to different public land mobile networks (PLMNs) can discover each other. For example, devices can be roaming when they discover each other. In various example embodiments, devices may transition between direct path mode and local path mode without perceivable degradation to the users. Local path mode refers to a communication between two devices that includes an intermediary between the two devices. Local path mode may also be referred to herein as infrastructure mode, without limitation. A direct path may refer to a communication link between two devices that includes no intermediary between the two devices. Operators may enhance their location and presence information using proximity services.

Various embodiments described herein may also be implemented in various example public safety scenarios (use cases) that use proximity services. In an example public safety (PS) application of proximity services, two authorized public safety personnel (users) can communicate directly over a D2D link. In another example public safety application that uses proximity services, a PS D2D user can maintain multiple simultaneous 1-to-1 D2D sessions with different PS users.

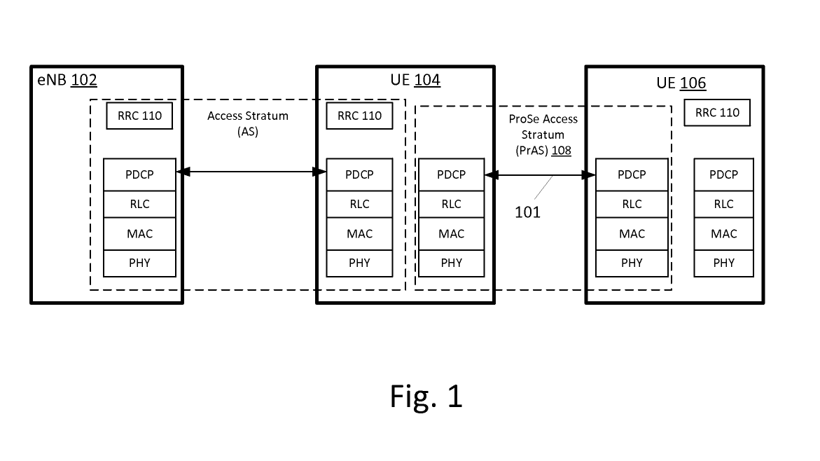

Referring to FIG. 1, an example protocol stack view of an LTE D2D direct path 101 is shown. FIG. 1 shows an example proximity service system 100 that includes an eNB 102 and multiple UEs, such as a first UE 104 and a second UE 106 for example. In accordance with the illustrated example, for LTE direct path transmission, one or more separate data radio bearers 108, illustrated as the proximity service access stratum (PrAS) 108, are setup for transmission of user plane data over the direct path 101. For example, bearers at each of one or more layers such as a physical layer (PHY), a media access control (MAC) layer, a radio link control (RLC) layer, and a packet data convergence protocol (PDCP) layers may be data terminated at the UEs 104 and 106. Each of the UEs 104 and 106 may be simultaneously connected with one another and with the eNB 102. In accordance with the illustrated example, a control plane, for instance a radio resource control 110, is terminated between the UE 104 the eNB 102. While the proximity service system 100 shows one eNB 102 and two UEs 104 and 106, it will be understood that any number of UEs and eNBs can be part of a proximity service system as desired.

The third generation partnership project (3GPP), the standardization body that creates specifications for Proximity Services (ProSe), has defined security requirements for direct communication between one or more UEs. Embodiments described herein enable systems to meet at least some of these security requirements. For example, an evolved packet system (EPS), which refers to an example architecture designed for LTE, that is constructed in accordance with various embodiments described herein may ensure that the confidentiality and integrity of data (e.g., user data, network signaling data) over a proximity service communication and a ProSe-assisted WLAN direct communication path is secure to a level at least comparable with that provided by an existing 3GPP system. It is recognized herein that the EPS is only required by 3GPP to provide for confidentiality and integrity protection for signaling (e.g., access stratum (AS) and non-access stratum (NAS)). That is, user plane data may be only confidentiality protected in accordance with requirements of 3GPP.

Embodiments described herein enable an EPS to protect the confidentiality of the subscribers, UEs, and users' permanent identities when ProSe discovery and communication is used. An example EPS may further include confidentiality features that enable the subscribers, UEs, and users' permanent identities to be protected when ProSe-assisted WLAN direct communication is used.

As described herein, a proximity services system may ensure the authenticity of proximity services discovery information used by an application that is authorized by the operator and the user. For example, the permission to be discoverable may be given by the user and may be executed by the EPS, subject to operator control on a per application basis. By way of another example, the EPS may restrict proximity services discovery information to ProSe-enabled UEs and applications that have been authorized by the users and operator. Example systems described herein may support regional or national regulatory requirements (e.g., lawful intercept).

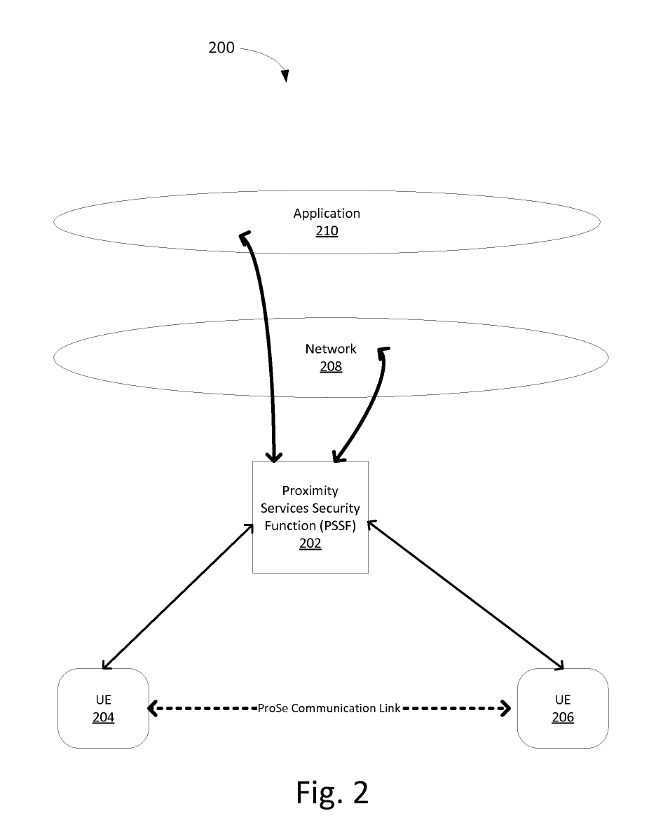

Referring to FIG. 2, in accordance with the illustrated embodiment, an example proximity services system 200 includes a proximity service security function (PSSF) 202. The proximity services system 200 can include one or more UEs, for instance a first UE 204 and a second UE 206, that communicate with the PSSF 202. While the illustrated embodiment depicts two UEs in the proximity services system 200, it will be understood that any number of UEs can be included in the proximity services system as desired. The PSSF 202 may be located, for example and without limitation: at an eNB; at a mobile management entity (MME); as part of a proximity services (ProSe) server; in an entity at the application layer, such as at an access network discovery and selection function (ANDSF) for example; at a UE; or as a stand-alone entity. As used herein, a ProSe server refers to a server that provides proximity services. For example, a ProSe server may provide proximity services to a pair of Peer-to-Peer (P2P) users or to a group of users. Example proximity services include, without limitation, aiding UEs or network entities in creating radio-bearers to enable direct or indirect communications, managing data flow, managing of user identities (IDs) at the application layer to network IDs, adapting general client/server applications and services to P2P sessions or group sessions, or providing quality of service (QoS) and security. Security may be achieved by means of a PSSF, which may be implemented as part of the ProSe Server. In an example embodiment, an entity that corresponds to the PSSF 202 is located on the UEs 204 and 206. The entity that corresponds to the PSSF 202 may perform a subset of operations similar to functions that the PSSF 202 performs. Thus, for example, the entity that corresponds to the PSSF 202 may be referred to as a ProSe client. The ProSe client may also function as a ProSe proxy function, which can mimic functions, for instance all functions, that are performed by the PSSF 202. Capabilities, as described further below, that the PSSF 202 can perform include ProSe session key generation and distribution. Further, the PSSF 202 may function as a ProSe security policy decision point. By way of another example, the PSSF 202 may aid in lawful interception (e.g., Key Escrow) and may manage privacy and identities (e.g., temporary identities). By way of yet another example, as further described below, the PSSF 202 may also function as a certificate authority, private key generator (PKG), and/or an identity provider (IdP).

In some embodiments, the PSSF 202 resides in a central coordinating entity on a network, such as a network 208 in accordance with the illustrated embodiment shown in FIG. 2. The central coordinating entity may be a network entity, such as a ProSe server, an MME, or an eNB for example. Alternatively, the central coordinating entity may be a UE, such as one of the UEs 204 and 206 for example, that act as a cluster head (CH).

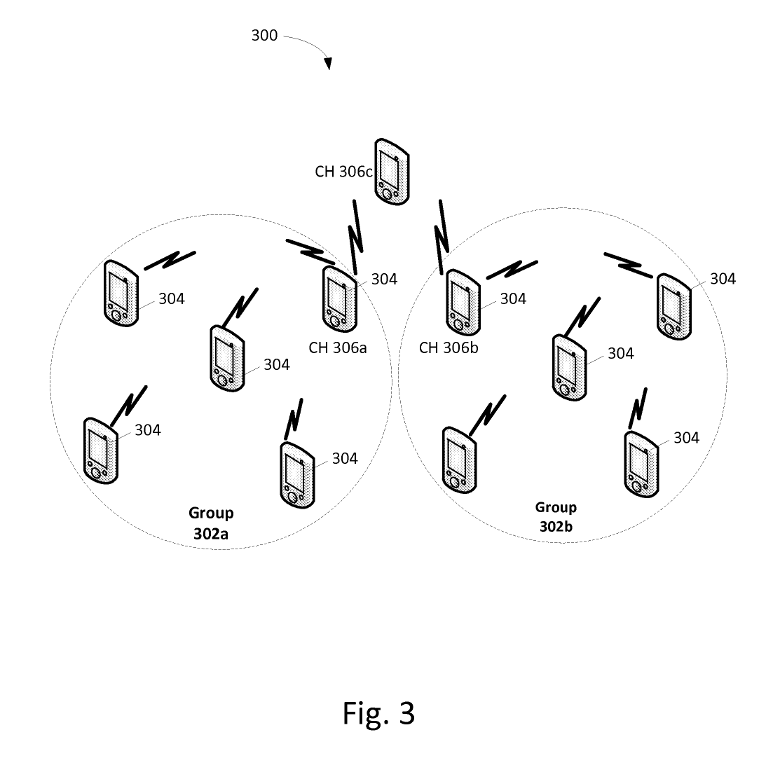

Referring to FIG. 3, an example cluster head (CH) system 300 may include one or more groups, such as a first group 302a and a second group 302b. Though the illustrated CH system 300 includes two groups, it will be understood that any number of groups, for instance more or less than two, can be included in a CH system as desired. As used herein, groups may also be referred to as clusters, without limitation. Each of the groups 302a and 302b can include one or more UEs 304. Further, each of the first and second groups 302a-b can include a CH. For example, in accordance with the illustrated embodiment, the first group 302a includes one UE 304 that is a CH, for instance a first CH 306a, and the second group 302b includes one UE 304 that is a CH, for instance a second CH 306b. In accordance with the illustrated embodiment, the first and second cluster heads 306a and 306b provide synchronization, scheduling, and security. Thus, the first and second cluster heads 306a and 306b can be considered trusted entities within each of the first and second groups 302a and 302b, respectively. In an example embodiment, another CH, for instance a third CH 306c, is a trusted entity that is trusted by the first CH 306a and the second CH 306b. Because the UEs 304 may trust their respective CH, and because the first and second CH 306a and 306b may trust the third CH 306c, the UEs 304 may trust the third CH 306c based on transitive trust, for example. Thus, the third CH 306c may offer security services to UEs 304 in both of the first and second groups 302a and 302b that would like to communicate with one another. For example, each of the cluster heads 306a-c may perform security functions that include serving as an authentication server, a PSSF, a private key generator (PKG) for identity-based encryption (IBE), an identity provider (IdP), a certificate authority, or any appropriate combination thereof A CH that serves as an IdP can provide trust within its group or between groups. Similarly, a CH that serves as a certification authority can be an authority for certifications within its group (intra-group CA) or between groups (inter-group CA). Though the cluster heads 306a-b may be the coordinating entity for their respective groups 302a-b in an out-of-coverage scenario, in some embodiments the coordinating entity, such as one of the cluster heads 306a-b for example, may have network coverage while other UEs 304 in the groups 302a-b do not have access to a cellular network or another external network. Thus, the cluster heads 306a-b can facilitate communications within the group of which they are a member, to outside groups that are separate from their own group, or to another network, such as a network controlled by a mobile network operator (MNO) for example.

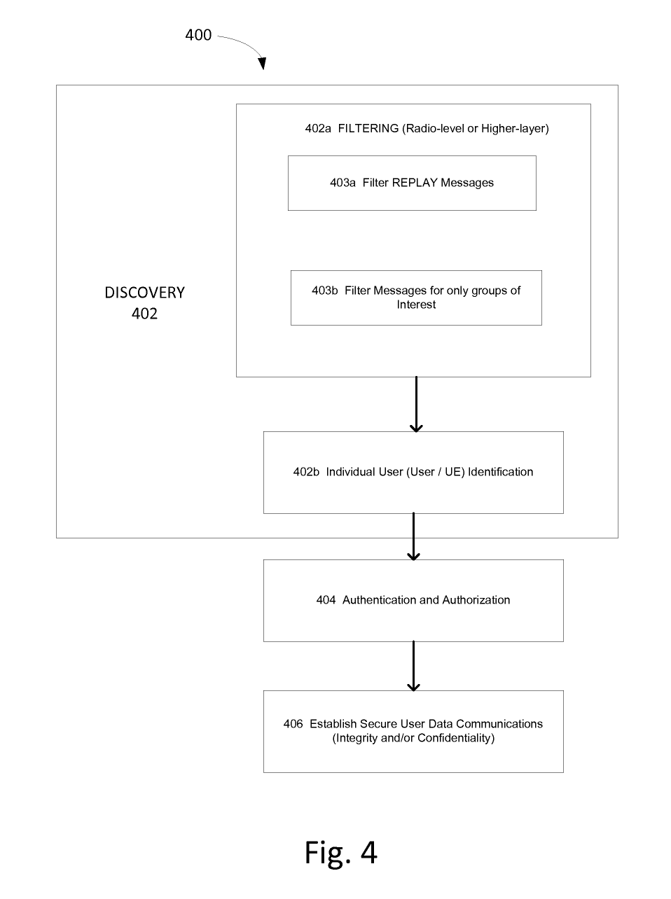

Referring to FIG. 4, in accordance with the illustrated embodiment, an example depiction of ProSe security functionality includes a combination of functions 400. A subset of the functions 400 may be run at any time depending upon security requirements. Further, in accordance with various embodiments, at least some of the functions 400 are combined for greater efficiency. The functions 400 may be run at different layers of a protocol stack.

Still referring to FIG. 4, at 402, a discovery is performed in which a user of interest is identified. An identity of the user may be restricted, for example protected for privacy reasons, or unrestricted. In accordance with the illustrated embodiment, the discovery at 402 is followed by an authentication and authorization, at 404, and an establishment of a secure user data communication channel, at 406. In an alternative implementation, the discovery at 402 is not followed by the authentication and authorization at 404. Further, in some cases, the discovery at 402 may be omitted from the functions 400. By way of example, walkie-talkies may perform authentication and authorization without performing discovery. At 402, in accordance with the illustrated embodiment, the discovery includes filtering at 402a. The discovery may include efficiently filtering out proximity service or beacon messages such that only messages that are deemed to be of interest are processed. For example, at 403a, replay messages are filtered such that replayed beacon messages are identified so that the replayed beacon messages are not further processed. At 403b, messages are further filtered by groups of interest. If the messages are not within a particular group of interest, they are not processed further. For example, messages may be filtered depending on whether they include particular membership information or other identifying data. In some instances, the filtering of messages of interest belonging to a particular group performed at 403b may be performed before the filtering of replay messages is performed at 403a. Filtering in this order may be useful, for example, when at least some information that is related to replay protection may be buried deep in a frame or packet. In such an instance, for example, a message packet may be identified as not belonging to a particular group of interest before deeper portions of the message packet are checked. Thus, the message packet can be discarded before filtering of replay messages is performed, which is more efficient as compared to a scenario in which the end portion of a message must be checked for replay messages.

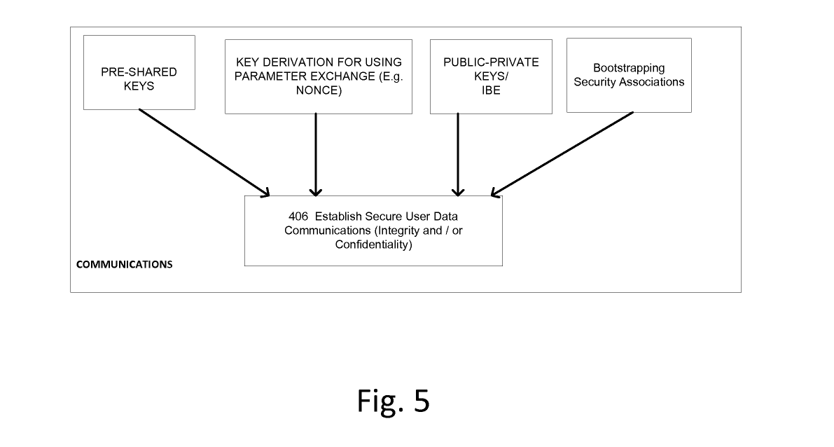

With continuing reference to FIG. 4, after the messages are filtered, in accordance with the illustrated embodiment, individual users and/or UEs are identified, at 402b. The identity of the user/UE corresponds to the user/UE that sent the ProSe discovery message. At 404, the authentication and authorization may be performed, for example, after the user and/or UE that sent the message has been identified. For example, the user or UE may be authenticated to verify that the user or UE is who he/she/it claims to be. In some scenarios, such as during a restricted discovery for example, authorization may be performed prior to discovery and filtering such that the UE that receives a message obtains an authorization code to enable decoding of the discovery ProSe or beacon information in the message. At 406, keys may be obtained. The keys may be obtained using various means (see also FIG. 5). At 406, keys may also be derived (generated), and the derived keys may be used to encrypt and integrity-protect user data communications. By way of example, a public safety worker may want communications to be encrypted and messages to be authenticated to ensure that P2P communications are only received and processed by intended personnel.

Referring also to FIG. 5, the key generation that may occur at 406 may be based on a shared secret, a public key, or a combination thereof As shown and as described further herein, establishing secure user data communications at 406 may be based on pre-shared keys 502, a key derivation 504, a public/private key pair (e.g., IBE) 506, a bootstrapped security association 508, or any appropriate combination thereof For example, in an example shared secret scenario, the trust that is generated between a UE, such as one of the UEs 204 and 206 depicted in FIG. 2, and a network, such as the network 208 depicted in FIG. 2, may be leveraged in order to derive keys for authentication and to provide confidentiality. Also, as further described below, the generated trust may be leveraged to ensure the integrity of data that is communicated between two UEs, such as the first and second UEs 204 and 206 for example. In an example public key scenario, dynamically generated or static public/private key pairs may be used for UE authentication, message authentication, and session key derivation. Alternatively, PM-based systems may be used. In an example embodiment that uses a hybrid approach to key generation, key generation is based on a shared secret and a public key. For example, a shared secret may be used to derive public/private key pairs or an identity based on a public key (e.g., identity based encryption (IBE)), or a PKI or public/private key pair may be used to create a secure tunnel in order to derive a shared secret.

In various example embodiments described below, existing security associations are exploited to establish secure D2D communications. For example, existing security associations between a UE and a base station (e.g., eNB), between a UE and MME, between a UE and an application entity, or the like, may be exploited to derive other security associations. The aforementioned existing security associations may be leveraged to derive ProSe security associations at the network level (e.g., radio, RAN) and/or at higher levels (e.g., at the application level).

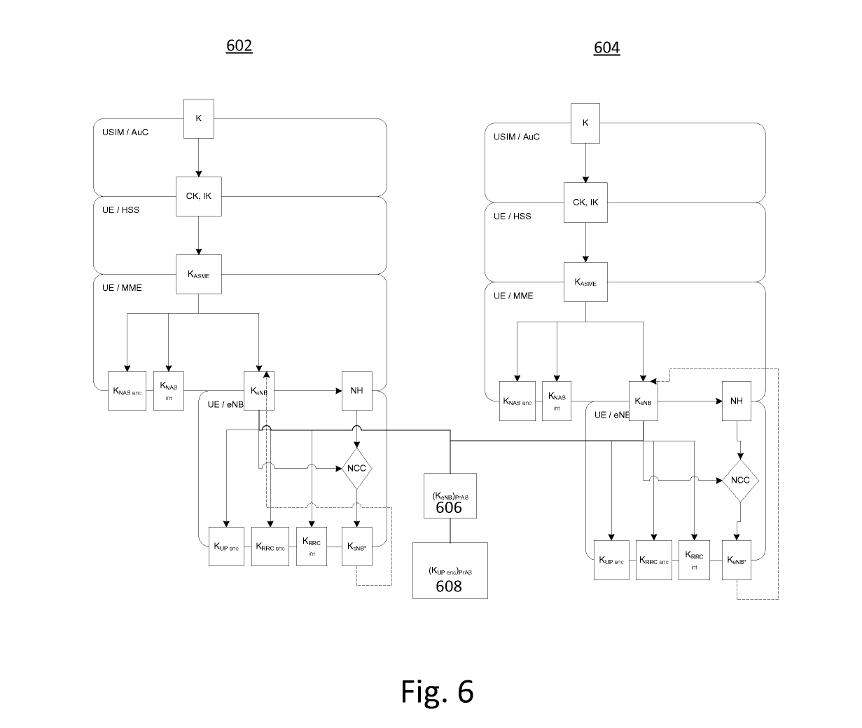

For example, referring to FIG. 6, a first UE 602 and a second UE 604 leverage respective access network-layer security associations to create a proximity service network-layer association. In accordance with the illustrated embodiment, the ProSe network layer association, and in particular a root key 606 ((K_{eNB})_{PrAS}) that is derived and associated with the ProSe network layer association, may be used in order to derive a user-plane communication key 608 (K_{UPenc})_{PrAS}). The user-plane communication key can be used to cipher user data that is transferred between the UEs 602 and 604. In an alternative embodiment, the root key 606 ((K_{eNB})_{PrAS}) is the root key for proximity service discovery and communication, and it is derived from a network key (K_{eNB}). The root key 606 ((K_{eNB})_{PrAS}) may also be referred to as the Group Direct Link Master Key (GDLMK). For example, keys (K_{eNB})_{PrAS} and (K_{Upenc})_{PrAS} may be derived from a key derivation function (KDF) using input including key material provided by a peer UE, for example via an eNB or directly from the peer UE. In scenarios in which two UEs request proximity services and the UEs are under the coverage of the same eNB, a PSSF may be invoked and may be located on the eNB.

With continuing reference to FIG. 6, in accordance with the illustrated embodiment, the UEs 604 and 602 each have a unique existing security association with a MME. The UEs 604 and 602 further have a key, which is illustrated as K_{ASME} in FIG. 6, that corresponds to the existing security association. As shown, each key K_{ASME} is derived based on a security association and a cipher key (CK) and an identity key (IK). Each CK and IK may have been derived as part of an authentication and key agreement (AKA) protocol that is performed between each UE and a home subscriber server (HSS) of an authentication center (AuC), which may be referred to collectively as an HSS/AuC. The AKA protocol may be performed according to 3GPP LTE/UMTS standards. In an example embodiment, a key, which may be referred to as a first derivative key, is derived from the network key K_{eNB} associated between the first UE 602 and the eNB. Another key, which may be referred to as a second derivative key, is derived from the network key K_{eNB} associated between the second UE 602 and the eNB. Based on the first and second derivative keys, a root key 606 ((K_{eNB})_{PrAS}) is derived that binds the two network associations at the ProSe Layer without affecting the security of the existing network layer associations between each of the UEs 602 and 604 and their respective eNBs. As shown, using the root key 606 (K_{eNB})_{PrAS} as the base key for a ProSe session, a user-plane communication key 608 ((K_{UP enc})_{PrAS}) is derived for providing secure ProSe communications. The root key 606 is also referred to as a common key or a ProSe session key herein.

In an example embodiment, as part of securing a ProSe session, the user-plane communication key 608 ((K_{UP enc})_{PrAS}) is derived from the ProSe Session key (K_{eNB})_{PrAS}. The user-plane communication key may providing confidentiality to a UE/user's ProSe communications by encrypting the communications in one direction (e.g., UE 602 to UE 604). In one embodiment, another user-plane communication key (K_{Downenc})_{PrAS} may be generated for encrypting the ProSe communications in the other direction (e.g., from UE 604 to UE 602). Alternatively, one key may be used for providing confidentiality in both directions. For example, an encryption key (K_{enc})_{PrAS} may encrypt ProSe communications between the first UE 602 and the second UE 604 in both directions. Additional keys may be derived from the root key 606 (K_{eNB})_{PrAS}. For example, one or more additional keys may provide integrity protection to a user's ProSe communications. One or more additional keys may further provide integrity protection to control or signaling messages that are associated with a ProSe communication session. The one or more keys used for integrity protection of ProSe communications may also be used for message authentication. Further, one or more additional keys may be generated for non-repudiation, as described further below. In some cases, example algorithms used for encryption, integrity protection, message authentication, digital signatures, or the like may be dictated by the network, such as an MME, eNB, PSSF, or other network entities. In other cases, algorithms may be negotiated between the UEs using the network infrastructure or during the D2D link setup process.

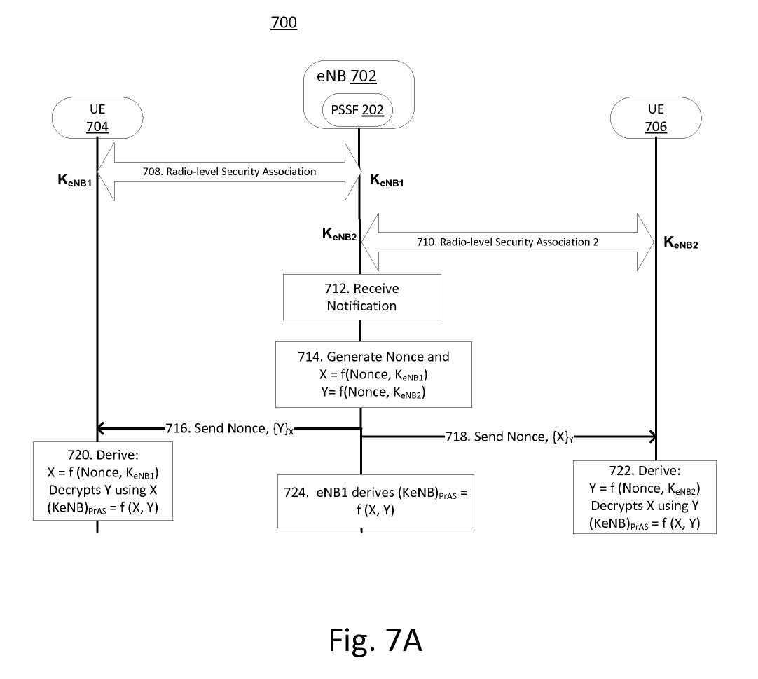

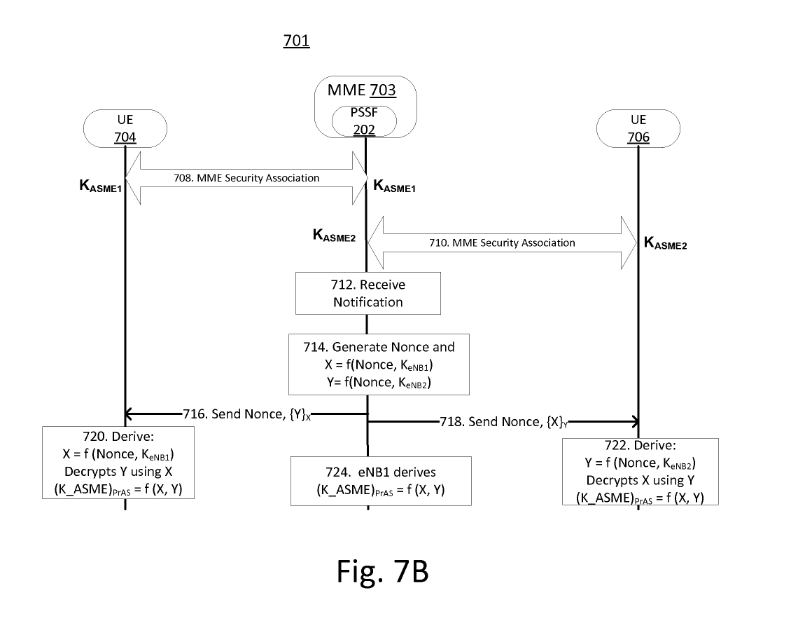

Referring now to FIG. 7A, an example system 700 includes an eNB 702, a first UE 704, and a second UE 706. The first and second UE 704 and 706 can communicate to a cellular network via the eNB 702. FIG. 7A is a flow diagram for key generation and distribution according to an example embodiment in which the proximity service security function (PSSF) 202 is implemented on the eNB 702. It will be appreciated that the example system 700 is simplified to facilitate description of the disclosed subject matter and is not intended to limit the scope of this disclosure. Other devices, systems, and configurations may be used to implement the embodiments disclosed herein in addition to, or instead of, a system such as the system 700, and all such embodiments are contemplated as within the scope of the present disclosure. In accordance with the illustrated embodiment, at 708, a radio-level security association is established between the first UE 704 and the eNB 702 as part of an initial network connection, for example an initial LTE connection. A first key K_{eNB1} is derived by the first UE 704, and the first key K_{eNB1} may be delivered to the eNB 702 from the network. Alternatively, the first key K_{eNB1} may be generated or extracted by the eNB 702 based on keying material provided by the network. Thus, the PSSF 202 may obtain the first key, and the eNB 702 may generally be referred to as network entity. Therefore, the PSSF 202 can obtain the first key that is associated with a pre-established security association between the first UE 702 and a network entity, such as the eNB 702 for example. The first key may also be referred to as a shared secret between the first UE 704 and the eNB 702. Similarly, at 710, a radio-level security association is established between the second UE 706 and the eNB 702. In accordance with the illustrated embodiment, at 710, a second key K_{eNB2} is derived by the second UE 706. The second key may be obtained by the PSSF 202. Thus, the PSSF 202 can obtain the second key that is associated with a pre-established security association between the second UE 706 and a network entity, such as the eNB 702 for example. The second key may also be referred to as a shared secret between the second UE 706 and the eNB 702.

Still referring to FIG. 7A, in accordance with the illustrated embodiment, at 712, the PSSF 202 receives a notification concerning proximity communications. In some cases, the functions 400 illustrated in FIG. 4 may be performed by one or more of the UEs 704 and 706 before the notification is received at 712. As used herein, proximity communications refers to wireless P2P or D2D communications. Based on the notification, for example, the PSSF 202 initiates a proximity services key generation function. The received notification may indicate that the first UE 704 and the second UE 706 desire to engage in proximity communications with each other. The notification may be provided by, for example, one of the first and second UEs 704 and 706, an application, a ProSe server, or the like. At 714, the PSSF 202 generates a nonce. Further, the PSSF 202 may derive a first intermediate key that is equal to a function of the nonce and the first key K_{eNB1}. The first intermediate key may also be derived based on the nonce and a derivative of the first key K_{eNB1}. The derivative of the first key may be referred to as a first derivative key K_{eNB1}⁺. In some cases, the first derivative key K_{eNB1}⁺ may be used at least primarily, for instance exclusively, for ProSe services. For convenience, the first intermediate key is referred to as “X” and the function that generates X may be represented by f (Nonce, K_{eNB1}) or f(Nonce, K_{eNB1}⁺). The function that generates X may be a HMAC-SHA-256 function, for example. Similarly, at 714, the PSSF 202 may derive a second intermediate key that is equal to a function of the nonce and the second key K_{eNB2}. The second intermediate key may also be derived based on the nonce and a derivative of the second key K_{eNB2}. The derivative of the second key may be referred to as a second derivative key K_{eNB2}⁺. In some cases, the second derivative key K_{eNB2}⁺ may be used at least primarily, for instance exclusively, for ProSe services. For convenience, the second intermediate key is referred to as “Y” and the function that generates Y may be represented by f (Nonce, K_{eNB2}) or f(Nonce, K_{eNB2}⁺). In accordance with the illustrated embodiment, at 716, the PSSF 202 sends (transmits) the nonce and second intermediate key Y to the first UE 704. The second intermediate key Y may be encrypted using X, and thus the encrypted value of Y may be represented by “{Y}ₓ”. At 718, in accordance with the illustrated embodiment, the PSSF 202 sends (transmits) the nonce and the second intermediate key X to the second UE 706. The second intermediate key X may be encrypted using Y, and thus the encrypted value of X may be represented by {Y}ₓ. At 720, the first UE 704 derives X from the function of the nonce and the first key, and further decrypts Y using X. The first UE 704 may generate a third key (KeNB)_{PrAS} that is equal to a function of the first intermediate key X and second intermediate key Y, and thus can be referred to as f(X, Y).

With continuing reference to FIG. 7A, at 722, the second UE 706 derives Y from the function of the nonce and the second key, and further decrypts X using Y. In accordance with the illustrated embodiment, the second UE 704 also generates the third key (KeNB)_{PrAS} that is equal to a function of the first intermediate key X and the second intermediate key Y. The third key (KeNB)_{PrAS} may form the root-key for ProSe communications, and thus the third key can also be referred to as a common shared key for securing proximity communications between the first UE 704 and the second UE 706. Thus, the PSSF 202 may derive, based on the first key and the second key, first and second intermediate keys that can be used by the first UE 704 and the second UE 706, respectively, to derive a common shared key for securing proximity communications between the first UE 704 and the second UE 706. At 724, the PSSF 202 may optionally generate the third key (K_{eNB})_{PrAS}, for example, if lawful intercept (LI) was required by the network. In some cases, the UEs 704 and 706 may derive additional keys from the third key (KeNB)_{PrAS}. For example, additional keys may be derived through the secure D2D connection, which may have been secured using the third key, between the first UE 704 and the second UE 706 such the eNB 702 and other network entities are not privy to the additional keys. Thus, in accordance with an example embodiment, one or more additional keys may be derived from the third key (KeNB)_{PrAS} via a D2D connection such that only the devices in the D2D connection possess the one or more additional keys.

In an alternative embodiment, two nonces, for instance a first nonce (Nonce1) and a second nonce (Nonce2), are generated by the PSSF 202 at 714. The first and second nonces may be used to compute the first intermediate key X=f (Nonce1, K_{eNB1}) and the second intermediate key Y=f (Nonce2, K_{eNB2}), respectively. Thus, the PSSF 202 may send the second nonce and the second intermediate key Y that is encrypted with the first intermediate key X to the first UE 704, and the PSSF 202 may send the first nonce and first intermediate key X that is encrypted with the second intermediate key Y to the second UE 706. Alternatively, the UEs 704 and 706 may generate their own nonces that are then sent to the PSSF 202 via one or more ProSe servers that are connected to the UEs 704 and 706. Further, the UEs 704 and 706 may send the first and second intermediate keys X and Y to one another by encrypting X and Y with their respective public keys.

In an alternative embodiment, referring to FIG. 7B, an example system 701 includes a mobile management entity (MME) 703, the first UE 704, and the second UE 706. FIG. 7B is a flow diagram for key generation and distribution according to an example embodiment in which the proximity service security function (PSSF) 202 is implemented on the MME 703. The steps that are illustrated with respect to FIG. 7B are described with respect to FIG. 7A, except the eNB 702 in FIG. 7A is replaced with the MME 703 in FIG. 7B. Thus, for example, the first key that is derived by the first UE 702 in FIG. 7A and is obtained by the MME 703 is represented as first key K_{ASME1}, and the second key that is derived by the second UE 706 and is obtained by the MME 703 is represented as second key K_{ASME2}. The first key K_{ASME1} may alternatively be a derivative of a key that is established between the UE 704 and the MME 703. Similarly, the second key KASME2 may be a derivative of a key that is established between the UE 706 and the MME 703. The derivative keys may be created at least primarily, for instance exclusively, for proximity services. Further, referring to FIG. 7B, at 720, the first UE 704 may generate a third key (K_{ASME})_{PrAS} that is equal to a function of the first intermediate key X and the second intermediate key Y. At 722, the second UE 706 may generate a third key (K_{ASME})_{PrAS} that is equal to a function of the first intermediate key X and the second intermediate key Y. As described with reference to FIG. 7A, the third key (K_{ASME})_{PrAS} in FIG. 7B may also form the root-key for ProSe communications, and thus the third key can also be referred to as a common shared key for securing proximity communications between the first UE 704 and the second UE 706.

In an embodiment, keys that are shared between UEs are statically provisioned. In such an embodiment, referring generally to FIGS. 7A and 7B, keys (or keying material for deriving the keys) for securing ProSe communications may be provisioned by the PSSF 202 to the UEs 704 and 706. The keys or keying material may be provisioned without the UEs 704 and 706 having to provide or derive keying material. For example, referring again to FIGS. 7A and 7B, the third keys (KeNB)_{PrAS} and(K_{ASME})_{PrAs} may be provisioned directly to the first and second UEs 704 and 706 without requiring the keying material or the existing network-layer security association keys (K_{eNB}). Group identities and group keys and associations may be available on a SIM card or a secure storage. These keys may be provisioned by an organization, for example when the organization configures a device for a user. Such keys may be used, by UEs, to cryptographically and periodically derive session keys. Keying material may be sent to the UEs by the network so that the shared secrets within the SIM or smart card of a UE are used to derive newer keys.

In various example embodiments, network-layer authentication associations are bootstrapped to create ProSe application-layer security associations. For example, a network-level authentication between the UE 704 and the eNB 702 or the MME 703 may be used to create ProSe application-layer security associations, which can then be used to protect application layer communications between two peers, such as the first and second UE 704 and 706 for example, or between members within a group. Thus, application layer communications can be confidential and can be integrity protected. For example, ProSe communications at the network-layer may be protected in accordance with the example embodiments described with reference to FIGS. 7A and 7B, and ProSe application layer communications may be secured at substantially the same time as network-layer communications are secured.

In yet another example embodiment, application-layer security associations are reverse-bootstrapped for network-level access. For example, the PSSF 202 may invoke the services of an application-layer security assertion function, such as the network application function (NAF) as defined by the generic bootstrapping architecture (GBA) for example. The NAF may be invoked to facilitate ProSe key management. In accordance with an example embodiment, the keys that have been derived as part of the GBA protocol may be used to derive ProSe keys between two UEs, such as between the first UE 704 and the second UE 706. For example, any higher-layer associations may be re-used to generate keys that may be usable to derive the (KeNB)_{PrAS}, (K_{ASME})_{PrAS}, or other network-level keys for ProSe communications. Similar application layer security associations between, for example, users and Google or Facebook, may be bootstrapped to derive keys to protect ProSe network-layer or application-layer communications. The application layer association may be carried out using extensible authentication protocol (EAP) protocols over HTTP or, for example, using TLS based security associations leveraging HTTPS with a username and password. A PSSF that is located at an application server, such as a Facebook or Google server for example, may use existing Master Session Keys (MSK) associated with a security association between the user and the application server to derive a ProSe application-layer security association and corresponding keys.

For initialization of example implementations that are based on public keys, in one example embodiment, each UE may use a public and private key pair that is derived using a secure channel that is protected by keys derived from the K_{eNB}. Each UE may advertise its public key. For example, a UE may advertise its public key in a beacon message. In an example variant implementation, a public key can be derived from a temporary UE identity, based on identity based encryption (IBE) for example.

Referring generally to FIG. 7A, in another alternative scenario, if the eNB 702 is registered to discover ProSe participant UEs, the eNB 702 may configure each UE with a public key of the other UE. Thus, the eNB 702 may provision the first UE 704 with a public key of the second UE 706, and the eNB 702 may provision the second UE 706 with a public key of first UE 704. Further, each UE 704 and 706 may encrypt its respective beacon with its private key, and the other UE, which can be referred to as a peer UE, can decrypt the beacon information using the advertising UE's public key to authenticate the advertising UE. Thus, the first UE 704 may encrypt its beacon with a private key, and the second UE 706 may decrypt the beacon using the public key of the first UE 702. The second UE 706 may then authenticate the first UE 704 using the private key of the first UE 704. In some cases, when a UE detects that it has found one of the UEs for which it was looking, the UE may send an indication to the eNB 702. The eNB 702 may configure the UE with next hop parameters (e.g., Next Chaining Hop Counter (NCC), Next-Hop (NH)) to derive a shared secret using parameters. Parameters that are used to derive the shared secret may include, for example, a peer UE's public key, the UE's own private key, the NCC, the NH, or the like. Thus, key distribution to peer UEs by the eNB 702 may be substantially symmetric.

In another example embodiment, a UE may maintain one or more, for instance two, keys for each peer-to-peer communication link. For example, one key may be for outbound data, derived from its K_{eNB} and the peer UE's private key, and used for signing a message for creating a digital signature. Another key may be for the inbound link, derived from the KeNB and sender UE's public key, for verifying the sender's digital signature.

Referring generally to FIGS. 2 and 7A-B, the PSSF 202 may act as a certificate authority or “notary” that authenticates the public key that belongs to the UE that claims it. Thus, the eNB 702 may function as a certificate authority (CA) or a notary in above-described scenarios, such as the scenario depicted in FIG. 7A. Similarly, the MME 703 or a ProSe Server may function as the CA in the scenario depicted in FIG. 7B. Alternatively, the key derivation can use access network discovery and selection (ANDSF) policies as described below.

In an example embodiment in which discovery and key management uses a ProSe server, a given UE registers with the ProSe server for a particular application and/or for a particular interest. The ProSe server provides an application identity (AppId) and/or a mask to the UE, directly or through an eNB and/or an MME. The UE may use the AppId to generate the mask or may obtain the mask directly. The mask may be used for sending discovery beacon information to the another UE. Alternatively, the beacon may be encrypted with a public key of the intended receiver, and an entity that is able to decrypt the beacon using its private key may identify the sender. In yet another alternative implementation, the beacon may be encrypted with a group public key that is obtained from a ProSe server or based on the AppId. In such a implementation, a private key that is paired with the group public key is configured for all group members (e.g., users of Facebook). The group public key and the private key pair is used for discovery.

In an example embodiment in which discovery is based on ANDSF policy, one or more UEs may use ANDSF rules to discover other UEs. For example, a given UE may use ANDSF rules to discover another UE that is interested in the same service, user group, or peer-to-peer session, as the given UE. For example, suppose an application identity (AppID) complies with an ANDSF rule, then a user having the AppID, via a UE, detects a beacon. The UE may decrypt the beacon using one or more AppIds, for instance a list of AppIds, that correspond to the user of the UE. Further, a beacon generation function may be based on ANDSF location based rules. In an example rule, certain AppIds are used in certain locations, but not other locations. By way of example, in a public place, a rule may require that only a Facebook AppId is used, but the rule may allow other AppIDs to be used at home.

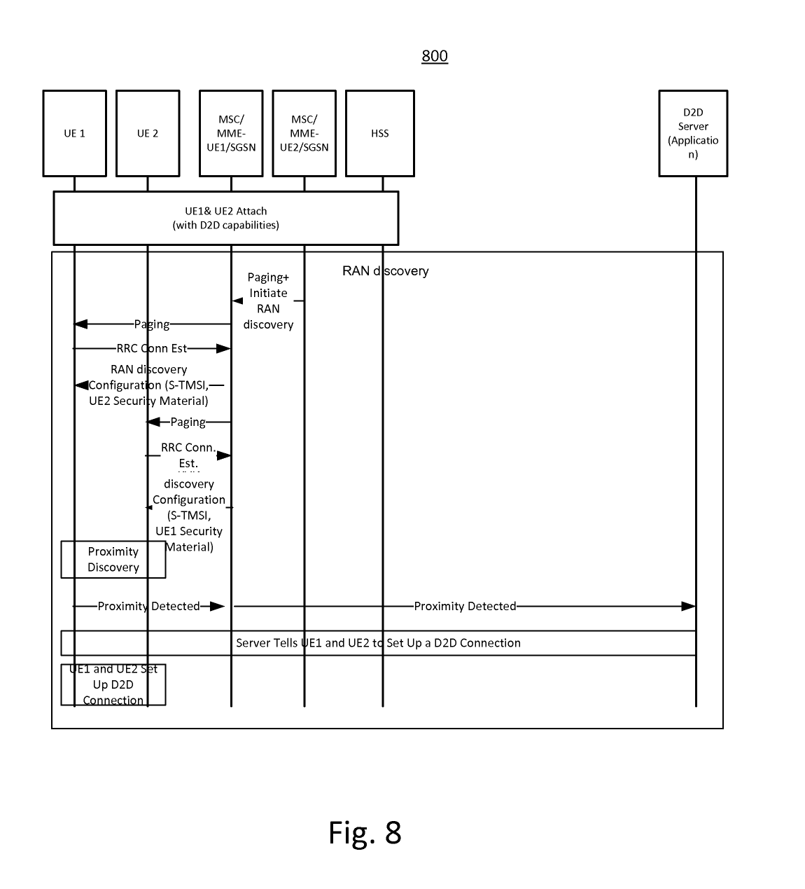

Referring to FIG. 8, in accordance with the illustrated embodiment, if a eNB is registered to discover two users (user1 and user2) of two UEs, the eNB may configure each UE with a public key of the other UE. FIG. 8 is a flow diagram that illustrates an example discovery method 800. It will be understood that various discovery mechanisms, such as the example discovery method 800, may precede the key derivations that are described with reference to FIGS. 6, 7A, 7B, 10A, and 10B.

Cryptographic protocols based on public-key methods may be based on certificates and Public Key Infrastructure (PKI) to support certificate management. In accordance with an example embodiment, the use of Identity-Based Encryption (IBE) protocols may allow simplification of infrastructure requirements via a Private-Key Generator (PKG), while providing better flexibility. In another embodiment, a user may be registered with a PSSF using only a public key without the requirement of a PM/certificate or IBE mechanisms.

The IBE family of key exchange protocols may have a minimal availability requirement for the upstream network access. In traditional public key methods, such connectivity is needed for certificate revocation as well as online certificate verification. Due to the nature of D2D, ProSe, and group communication (e.g., limited availability of upstream network access), the above-mentioned qualities of IBE protocols may help D2D, ProSe, and Group Communication key exchange and key management schemes.

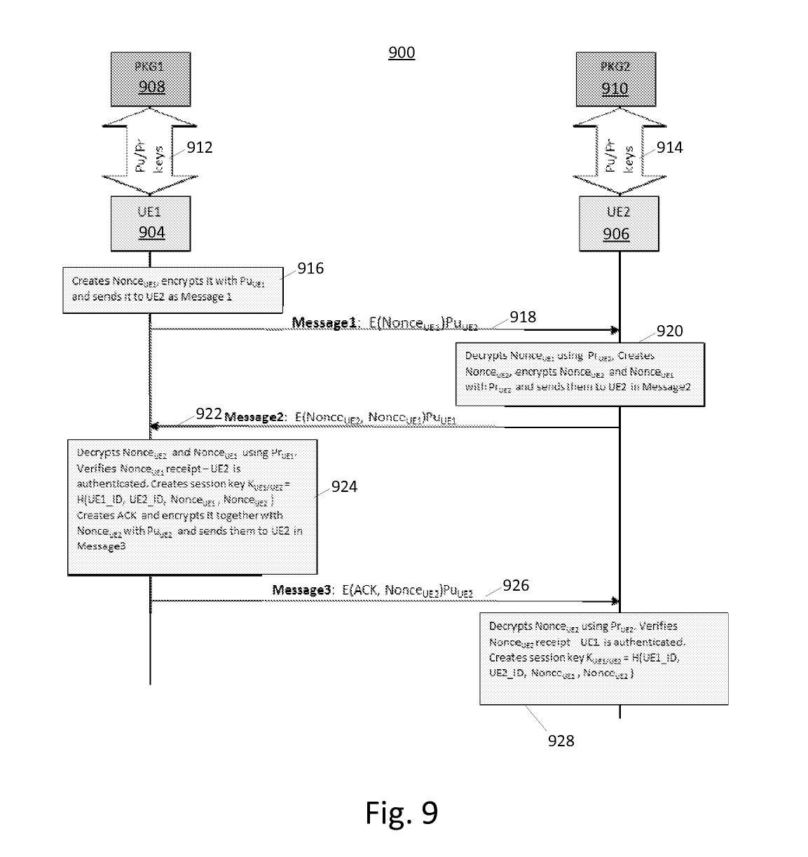

While traditional IBE protocols have a feature of a PKG being the de-facto key escrow for the key exchange, this feature may help with a Lawful Interception (LI) regulatory requirement that D2D, ProSe, and Group Communication may have to support. For example, FIG. 9 is a flow diagram for authenticated identity-based encryption (IBE) key exchange according to an example embodiment. Referring to FIG. 9, an example system 900 includes a first UE 904, a second UE 906, a first private key generator (PKG) 908, and a second PKG 910. It will be appreciated that the example system 900 is simplified to facilitate description of the disclosed subject matter and is not intended to limit the scope of this disclosure. Other devices, systems, and configurations may be used to implement the embodiments disclosed herein in addition to, or instead of, a system such as the system 900, and all such embodiments are contemplated as within the scope of the present disclosure.

Referring to FIG. 9, at 912, which may be referred to as a provisioning phase, the first UE 904 requests the PKG 908 for a public identity that may be used for ProSe services. The first UE 904 may obtain a public/private key pair (denoted Pu/Pr), which may be referred to as a first key, from the first PKG 908 based on a pre-established security association between the first UE 904 and the first PKG 908. Thus, the public identity that the first UE 904 requests and receives may be the first key associated with a pre-established security association between the first UE 904 and the first PKG 908. Similarly, at 914, which also may be referred to as a provisioning phase, the second UE 906 requests a public identity from the second PKG 910. The second UE 906 may obtain a public/private key pair (denoted Pu/Pr), which may be referred to as a second key, from the second PKG 910 based on a pre-established security association between the second UE 906 and the second PKG 910. Thus, the public identity that the second UE 906 requests and receives may be the second key associated with a pre-established security association between the second UE 906 and the second PKG 910. The first PKG 908 and the second PKG 910 may reside on a network entity, such as an eNB for example. Thus, the first PKG 908 and the second PKG 910 may each be referred to as network entities. Further, the UEs 906 and 908 may receive identities from the same private key generator or different private key generators.

The provisioning phases at 912 and 914, which may also be referred to as requisitions, may be performed before any ProSe communications occur between the first UE 904 and the second UE 906. Based on a trigger, such as the notification described with respect to FIGS. 7A and 7B (see 712), the first UE 904 may generate a first nonce (Nonce_{UE1}) and other keying material, at 916. The first nonce may be referred to as a first intermediate key. The first UE 904 may encrypt the first nonce with a public key of the second UE 906 (denoted Pu_{UE2}) or the public identity of the second UE 906. At 918, a message with the encrypted first nonce is sent to the second UE 906 from the first UE 904. At 920, upon receiving the message from the first UE 904, the second UE 906 decrypts the first nonce in accordance with the illustrated embodiment. The second UE 906 may decrypt the first nonce and other keying material using its private key, which is denoted as Pr_{UE2} in FIG. 9. At 920, the second UE 906 may generate a second (Nonce_{UE2}) and other keying material. The second nonce may be referred to as a second intermediate key. The first UE 904 may encrypt the second nonce with a public key of the first UE 904 (denoted Pu_{UE1}) or the public identity of the first UE 904. At 922, a message with the encrypted first nonce is sent to the first UE 904 from the second UE 906. The second UE 906 may optionally include the first nonce (Nonce_{UE1}) within the encrypted message content that is sent at 922. At 924, in accordance with the illustrated embodiment, the first UE 904 decrypts the nonces, which may be also be referred to generally as keying material. The first UE 904 may then derive ProSe session keys, which may also be referred to as third keys or common shared keys. For example, the common shared key may be derived by using a HMAC-SHA-256 function on the public identities of the first and second UEs 904 and 906, and the first and second nonces. Alternatively, the key(s) derived may be bound to a channel. For example, the keys may be a TLS master secret if the keys are bound to a TLS channel or to an EAP channel. Thus, the common shared key (ProSe session key) may be derived by using a HMAC-SHA-256 function on the public identities of the first and second UEs 904 and 906, the first and second nonces, and a channel ID.

With continuing reference to FIG. 9, at 926, the first UE 904 may send an acknowledgement (Ack) message to the second UE 906. The acknowledgement message may indicate a successful derivation and binding of the session keys. At 928, the second UE 906 may perform the same operations as the first UE 904 performs at 92 in order to derive the session keys, which may be bound to the channel. Thus, the common shared keys, which are also referred to as ProSe session keys, may then be used to secure ProSe communications between the first UE 904 and the second UE 906 by providing confidentiality and integrity.

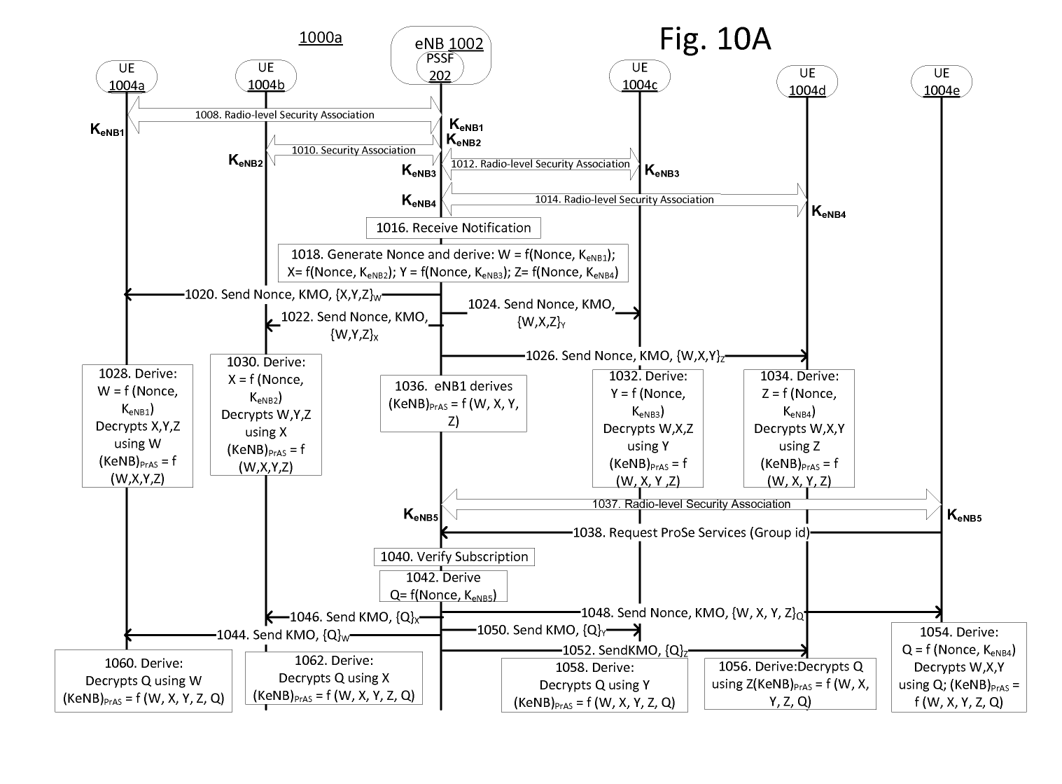

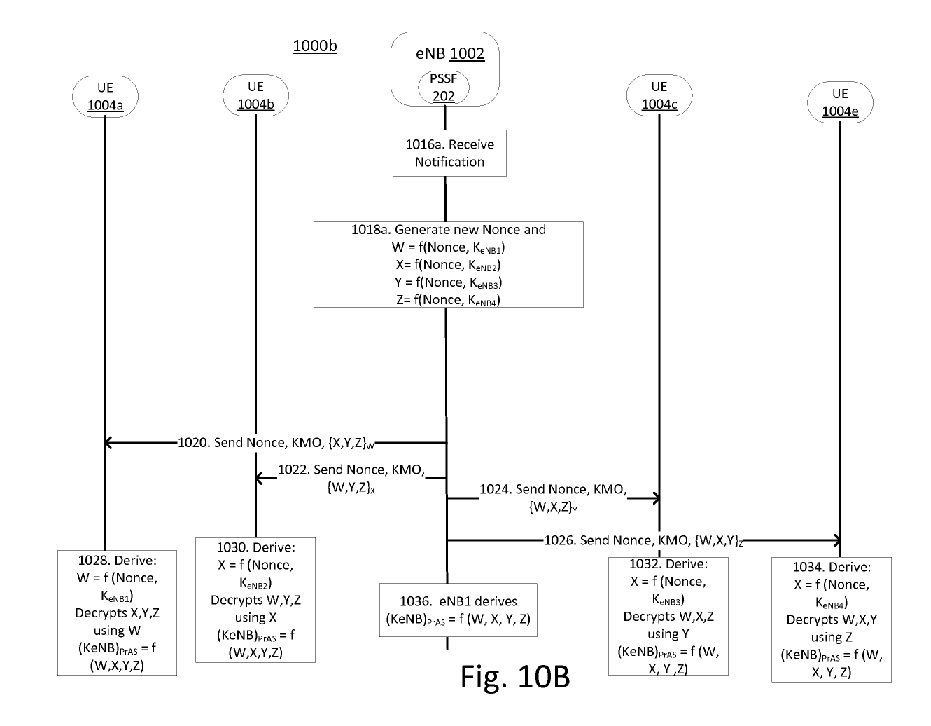

Referring now to FIG. 10A, an example system 1000a includes an eNB 1002 and one or more UEs 1004, for instance a first UE 1004a, a second UE 1004b, a third UE 1004c, a fourth UE 1004d, and a fifth UE 1004e. The one or more UEs 1004 may belong to a groups, such as one of the groups that are described with respect to FIG. 3. While five UEs are illustrated, it will be understood that the system 1000 can include any number of UEs as desired. The UEs 1004 communicate to a cellular network via the eNB 1002. Based on a subscription, the UEs 1004 may be provisioned with a group key by the network. In accordance with the illustrated embodiment, the PSSF 202 resides on the eNB 1002, but it will be understood that the PSSF may be alternatively located as desired. FIG. 10A illustrates a flow diagram demonstrating an example network-based group key derivation process.

Still referring to FIG. 10A, in accordance with the illustrated embodiment, at 1008, a radio-level security association is established between the first UE 1004a and the eNB 1002 as part of an initial network connection, for example an initial LTE connection. A first key K_{eNB1} is derived by the first UE 1004a, and the first key K_{eNB1} may be delivered to the eNB 1002 from the network. Thus, the PSSF 202 may obtain the first key. Therefore, the PSSF 202 can obtain the first key that is associated with a pre-established security association between the first UE 1004a and a network entity, such as the eNB 1002 for example. The first key may also be referred to as a shared secret between the first UE 1004a and the eNB 1002. Similarly, at 1010, a radio-level security association is established between the second UE 1004a and the eNB 1002. In accordance with the illustrated embodiment, at 1010, a second key K_{eNB2} is derived by the second UE 1004b. The second key may be obtained by the PSSF 202. At 1012, a radio-level security association is established between the third UE 1004c and the eNB 1002. In accordance with the illustrated embodiment, at 1012, a third key K_{eNB3} is derived by the third UE 1004c. The third key may be obtained by the PSSF 202. At 1014, a radio-level security association is established between the fourth UE 1004d and the eNB 1002. In accordance with the illustrated embodiment, at 1014, a fourth key K_{eNB4} is derived by the fourth UE 1004d. The fourth key may be obtained by the PSSF 202.

Still referring to FIG. 10A, in accordance with the illustrated embodiment, at 1016, the PSSF 202 receives a notification concerning proximity communications. The notification may be received from one of the UEs 1004 or a proximity services server, for example. Based on the notification, for example, the PSSF 202 initiates a proximity services key generation function. The received notification may indicate that the UEs 1004 desire to engage in proximity communications with each other. At 1018, the PSSF 202 generates a nonce. Further, the PSSF 202 may derive one or more intermediate keys, such as, for example, a first intermediate key W, a second intermediate key X, a third intermediate key Y, and a fourth intermediate key Z. Further, the PSSF 202 may generate an order in which the intermediate keys are to be mixed, which may be referred to as a key mixing order (KMO). As illustrated, the first intermediate key W is generated using a function of the nonce and the first key, the second intermediate key X is generated using a function of the nonce and the second key, the third intermediate key Y is generated using a function of the nonce and the third key, and the fourth intermediate key Z is generated using a function of the nonce and the fourth key. The function that generates the intermediate keys may be a HMAC-SHA-256 function, for example.

With continuing reference to FIG. 10A, in accordance with the illustrated embodiment, at 1020, the PSSF 202 sends the nonce, the KMO, and the second, third, and fourth, intermediate keys to the first UE 1004a. The second, third, and fourth intermediate keys may be encrypted with the first intermediate key W. At 1022, the PSSF 202 sends the nonce, the KMO, and the first, third, and fourth, intermediate keys to the second UE 1004b. The first, third, and fourth intermediate keys may be encrypted with the second intermediate key X. At 1024, the PSSF 202 sends the nonce, the KMO, and the first, second, and fourth intermediate keys to the third UE 1004c. The first, second, and fourth intermediate keys may be encrypted with the third intermediate key Y. At 1026, the PSSF 202 sends the nonce, the KMO, and the first, second, and third intermediate keys to the fourth UE 1004d. The first, second, and third intermediate keys may be encrypted with the fourth intermediate key Z.

At 1028, the first UE 1004a derives the first intermediate key W from the function of the nonce and the first key, and further decrypts X, Y, and Z using W. The first UE 1004a may generate a common key (KeNB)_{PrAS} that is equal to a function of the first intermediate key W, the second intermediate key X, the third intermediate key Y, and the third intermediate key Z, and thus the function can be referred to as f(W, X, Y, Z). At 1030, the second UE 1004a derives the second intermediate key X from the function of the nonce and the first key, and further decrypts W, Y, and Z using X. The second UE 1004a may generate the common key (KeNB)_{PrAS} that is equal to f(W, X, Y, Z). At 1032, the third UE 1004c derives the third intermediate key Y from the function of the nonce and the first key, and further decrypts W, X, and Z using Y. The third UE 1004c may generate the common key (KeNB)_{PrAS} that is equal to f(W, X, Y, Z). At 1034, the fourth UE 1004d derives the fourth intermediate key Z from the function of the nonce and the first key, and further decrypts W, X, and Y using Z. The fourth UE 1004d may generate the common key (KeNB)_{PrAS} that is equal to f(W, X, Y, Z). The common key KeNB_{PrAS} may form the root-key for ProSe communications, and thus the common key can also be referred to as a common shared key for securing proximity communications between the ones of the UEs 1004. At 1036, the eNB 1002, and in particular the PSSF 202, may also generate the common key (KeNB)_{PrAS}, for example, if lawful intercept (LI) was required by the network. Because the system 1000a may represent a group of UEs 1004, the illustrated common key (KeNB)_{PrAS} in FIG. 10A may be a group key (KeNB)_{PrAS} for communicating within the group. For example, the first UE 1004a and the second UE 1004a may belong to the group that includes one or more UEs 1004 in addition to the first UE 1004a and the second UE 1004b. Further, the group key (KeNB)_{PrAS} may be used to decrypt a message by one of the UEs 1004 belonging to the group after a digital signature of the message is verified.

Keys may be mixed using various means. The KMO describes a way to mix the keys. By way of example, the KMO may describe that the (K_{eNB})_{PrAS} is to be mixed in order W, X, Y, Z. In such an order, the UE 1004 derives the key: (K_{eNB})_{PrAS}=f(W, X, Y, Z). By way of another example, the KMO may describe that the (K_{eNB})_{PrAS} is to be mixed in order Y, Z, X, W. In such an order, the UE 1004 derives the key: (K_{eNB})_{PrAS}=f(Y, Z, X, W).

Referring again to FIG. 10A, if a new UE, for instance the fifth UE 1004e, joins the group of UEs 1004 in the system 1004e, and if a new key, for instance a fifth key K_{eNB5}, is associated with a pre-established (at 1037) security association between the fifth UE 1004e and the eNB 1002, then the PSSF 202 may derive a new intermediate key, for instance a fifth intermediate key Q. Thus, based on the new key, the new intermediate key Q may be derived. As described below, the new intermediate key Q may be used by the group of UEs 1004 to derive a new common shared key for securing proximity communications between the UEs 1004 in the group. The eNB 1002 may obtain the new key K_{eNB5}. In accordance with the illustrated embodiment, at 1038, the fifth UE 1004e requests the group ID from the eNB 1002, and in particular the PSSF 202. At 1040, the eNB 1002 verifies that the fifth UE 1004e is a subscriber to the group. At 1042, the fifth intermediate key Q may be derived as equal to a function of a nonce and the fifth key K_{eNB5}. The nonce may be the nonce that was generated at 1018. Alternatively, the nonce may be a new nonce, for instance a fifth nonce, generated at 1042. At 1044, the PSSF 202 may send the fifth intermediate key Q to the first UE 1004a, and Q may be encrypted using W. A new KMO indicating the order in which to construct the (K_{eNB})_{PrAS.} may also be sent to the first UE 1004a. Similarly, at 1046, the PSSF 202 may send Q to the second UE 1004b, and Q may be encrypted using X. Also, a new KMO indicating the order in which to construct the (K_{eNB})_{PrAS} may be sent to the second UE 1004. At 1050 and 1052, the PSSF 202 may send the fifth intermediate key Q to the third UE 1004c and the fourth UE 1004d, and Q may be encrypted with Y and Z, respectively. At 1048, the PSSF 202 sends the fifth UE 1004e, which is new to the group of UEs 1004, the intermediate keys: W, X, Y, Z encrypted by Q. The nonce from 1018 and the KMO may also be sent at 1048. Alternatively, a nonce that was generated at 1042 may be sent at 1048. At 1060, 1062, 1058, and 1056 the UEs 1004a-d, respectively, decrypt the fifth intermediate key Q using their respective intermediate key. The UEs 1004a-d generate a new common shared key (K_{eNB})_{PrAS}. At 1054, the fifth UE 1004e decrypts the intermediate keys W, X, Y, Z using its intermediate key Q that was derived using the fifth key K_{eNB5} and the nonce sent by the PSSF 202. The fifth UE 1004e generates the new common key (K_{eNB})_{PrAS}, which also may be referred to as a ProSe session key. Thus, the new intermediate key Q can be used by the group of UEs 1004 to derive the new common shared key (KeNB)PrAS for securing proximity communications between the UEs 1004 in the group. In an example embodiment, when one of the UEs 1004 leave the group, then a subset of new intermediate keys are generated and sent in an encrypted manner to each of the UEs 1004 that remain as members of the group. In the example embodiment, no new keying material is sent to the UE 1004 that left the group.

Referring generally to FIG. 10A, in accordance with another embodiment, dynamic key derivation may be performed on each of the UEs 1004. In such an embodiment, the UEs 1004 may synchronize with each other during a time when they have network coverage so that keys can be derived or generated later-on when out of coverage. One of the UEs 1004 may be elected master and may provide seeding material. Vector of seeding material (On-time Pad (OTP) and associated lifetime) are provided while the UEs are synchronized with each other. For example, the vector of seeding material may be a list of nonces or random values. In some cases, for example in a scenario in which the UEs 1004 are in coverage only during setup and are out of coverage for other times, a shared secret (Ki) on the USIM of the UEs 1004 may be leveraged. For example, the first UE that initiates the group and signs-in with the shared secret becomes the master or CH. Other members who receive the shared keys generate keys out of the share secret. Thus, there may be a key hierarchy associated with each group.

In another embodiment, the out-of-coverage group may function using a central coordinating entity. The central coordinating entity may be a UE acting as a cluster head (CH). In some cases, the central coordinating entity may be a CH that only provides synchronization. In other cases, the central coordinating entity is used only for providing both synchronization and scheduling and Security Functions such as a PSSF, Certificate Authority or PKG, Authentication Server, an Identity Provider (IdP), and inter-group trust provider.

In an example group communications scenario in which multiple users share the same group key, non-repudiation may become an issue. In order to counter non-repudiation, each UE or user may have a public/private key associated with the UE so that all messages are also digitally signed by individual private keys. Therefore, confidentiality may be provided by means of a shared secret, for example derived from the common key (K_{eNB})_{PrAS}. Integrity and message authentication may be provided by means of a digital signature produced by signing the hash of the message by the sending UE's private key. In accordance with an example embodiment, each receiving UE/User verifies the digital signature of the sending UE and then decrypts the message using the group key derived from the (K_{eNB})_{PrAS}. Thus, for example, a group key, such as the common key (KeNB)_{PrAS}, may be used to decrypt a message by one of the UEs belonging to the group after a digital signature of the message is verified, and the digital signature may be specific to an originator of the message. Thus, the originator or sender of the message may be identified and authenticated before a message is encrypted, thereby ensuring that sending UEs are members of the appropriate group.

A group key may be generated in multiple stages. The first stage may consist of obtaining an initial shared key, which can be referred to as a seed, for the group of interest. The second stage may include a refresh or rekeying based on a key refresh input. The key refresh algorithm may be implicitly generated using a synchronization code provided by the coordinating entity. The key refresh information may include an SFN number, nonce, time, group channel id, index, or similar input. Each group member may run a hash or specified algorithm to obtain a current key from the initial shared key.

In another embodiment that may be used for asynchronous deployments, key refresh information may include the time offset between the two cells that may belong within cells in a PLMN or different PLMNs.

In example embodiments for key renewal or key revocation, the common key (KeNB)_{PrAS} may have an associated lifetime. The lifetimes of the keys may depend upon the application that is being used. For example, the lifetime for a certain type of chat may be shorter than the lifetime of a key used for two users wanting to play a game.

In some cases, existing keys need to be revoked from members of a group that leave the group. FIG. 10B illustrates a signal flow in accordance with an example embodiment in which a new UE joins a group. Referring to FIG. 10B, an example system 1000b includes the eNB 1002 and one or more UEs 1004 that belong to a group, for instance the first UE 1004a, the second UE 1004b, the third UE 1004c, and a fifth UE 1004e. Referring also to FIG. 10A, the fourth UE 1004e that is in the system 1000a, is not in the system 1000b. For example, the common key of the fourth UE 1004d may have been revoked because the UE 1004d left the group of UEs 1004. At 1016a, the PSSF 102 receives a notification. The notification may indicate that the fourth UE 1004d has moved out of the group. The notification may further indicate that the fifth UE 1004e has joined the group. Based on the notification, at 1018a, a new nonce is generated and new intermediate keys are generated. Thereafter, a common shared key is derived as described with the respect to FIG. 7A. The common shared key is shared by the UE's 1004 to enable them to secure proximity communications between each other.

For restricted discovery, receivers need to be authorized. Thus, a shared key (e.g., shared secret) used by the transmitter may need to be refreshed periodically. When a new receiver UE requests authorization to discover a restricted UE, the new UE may be provided with the initial key and an authorization code, which can be used as key material to generate the final key (shared key) used by the transmitter. The receiver UE may need to re-request authorization periodically, and each time authorization is requested the receiver UE may be given a fresh authorization code.

In an embodiment, ProSe discovery may be performed by using smart filtering (e.g., see 402a in FIG. 4) of user or UE identities that are of interest, while also ensuring that a past communication from a party of interest (user or UE) is filtered so that malicious or non-malicious replay attacks are prevented (403a in FIG. 4). Filtering may be based on one or more interest groups. For example, messages that belong to a certain interest group, and which may be of no interest to a receiving UE, may be filtered (e.g., see 403b in FIG. 4). In some embodiments such filtering may be performed at the radio access layer or at a higher layer. Group identities may be used that are provided to the radio layers by an application. These group identities may be integrity protected and/or encrypted based on security requirements. If the group identities are integrity protected or encrypted, for example, then checking for these security features may be facilitated beforehand. Example group identities are provided below in Table 1.

TABLE 1
Example Group Identities

| Group Name | Group ID |
|---|---|
| Homeland Security | 1001 |
| FEMA | 1002 |
| Gaming | 501 |
| Social Networking | 502 |

The filtering process may also, or instead, involve identifying messages that may have been replayed intentionally or accidentally. Filtering of replayed messages may be employed using a preconfigured set of identities, where two UEs or users that would like to discover one another may be preconfigured with a set of temporary identities for a preconfigured duration that would then be used to discover one another. An identity table as illustrated below in Table 2 may be provisioned by a user to another user or UE that he or she would like to be discovered by.

TABLE 2
Example Group Identities

| Time (T) | Identity |
|---|---|
| 00:00-01:00 AM | a3bcd21489f |
| 01:00-02:00 AM | 482eab242e |
| 02:00-03:00 AM | 93cb2b338a |

A user or UE who wants to be discovered may provide the table to a user or users ahead of a discovery process. For example, during each interval of time, the associated identity may be used in the user's discovery message. A user that had been provided with the identity table uses it to look for discovery messages that carry the identity that is associated with that period of time. The mechanism described may not completely eliminate replay attacks, since replay attacks are still possible within the same time slots. However, the time slots may be made much smaller (e.g., five minutes or less) thus minimizing the attacks that may be possible. Slots may be any arbitrary value.

In an embodiment, one or more channel slots, codes, or synchronization sequences may be used to create identities. A user may create a temporary identity from his/her application had provided and then cryptographically mixing the identity with a fingerprint of the current channel slot, code, or synchronization sequence that is used for transmission of the discovery message. The capability to verify a synchronization sequence may provide a mechanism to protect, mitigate, or minimize replay attacks.

In an embodiment, an identification process for identifying a user or UE may include obtaining the identity information of a user who sent a discovery message. The process may not involve authentication in accordance with an example embodiment. In one embodiment, a discovery key may be generated in multiple stages. The first stage may be obtaining the initial shared key (or a seed) for the identity. The second stage may include refreshing or rekeying based on key refresh information provided by, for example, an embodiment as set forth herein. The key refresh information may be implicitly generated using synchronization code provided by a coordinating entity (for out-of-coverage situations, this may be a CH, while for in-coverage situations this may be a network entity such as an eNB, MME, or ProSe function, or provided by an application). The key refresh information may include SFN number, nonce, coordinated time (including time offset between cells if inter-cell discovery is being performed), group channel id, index or similar input. Each transmitter and potential receiver may run a hash or algorithm to obtain a current key from the initial shared key plus the key refresh material. In another embodiment, for asynchronous deployments, the key refresh information may include the time offset between the two cells.

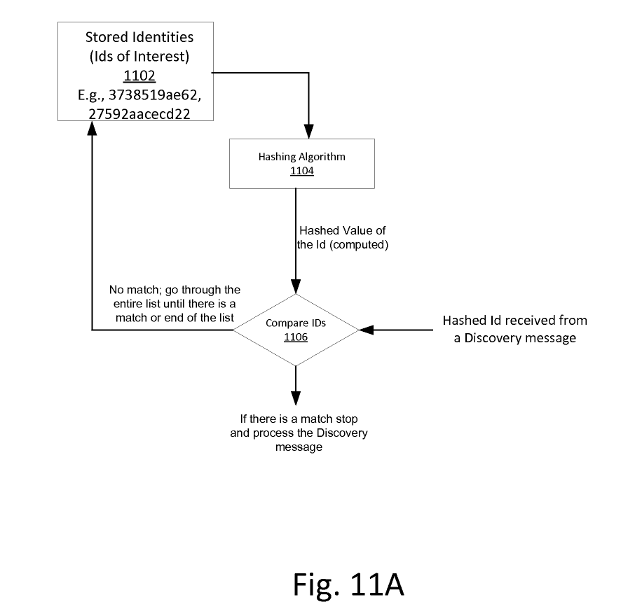

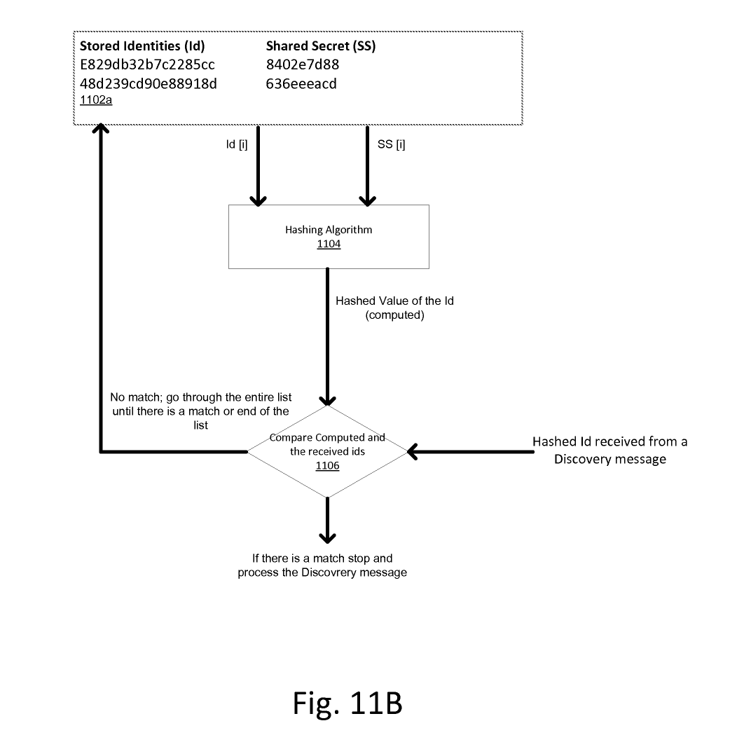

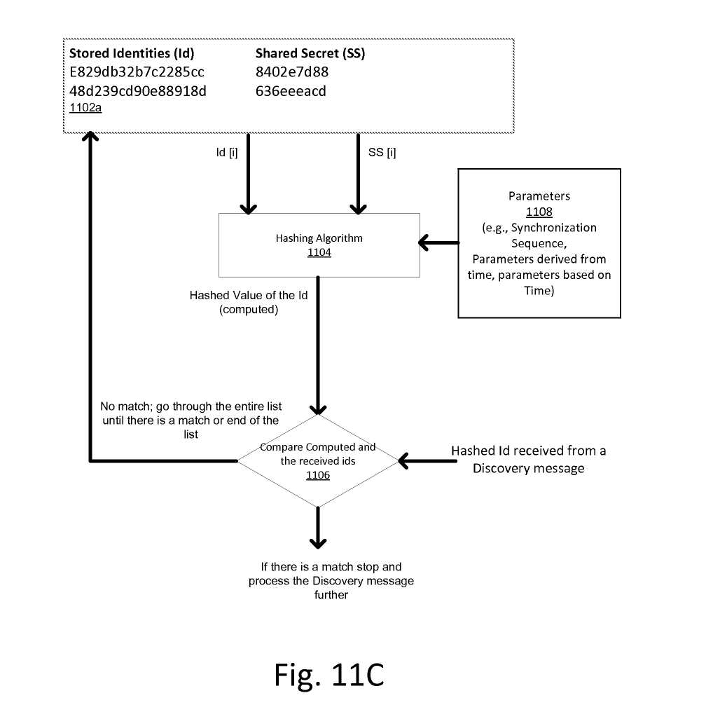

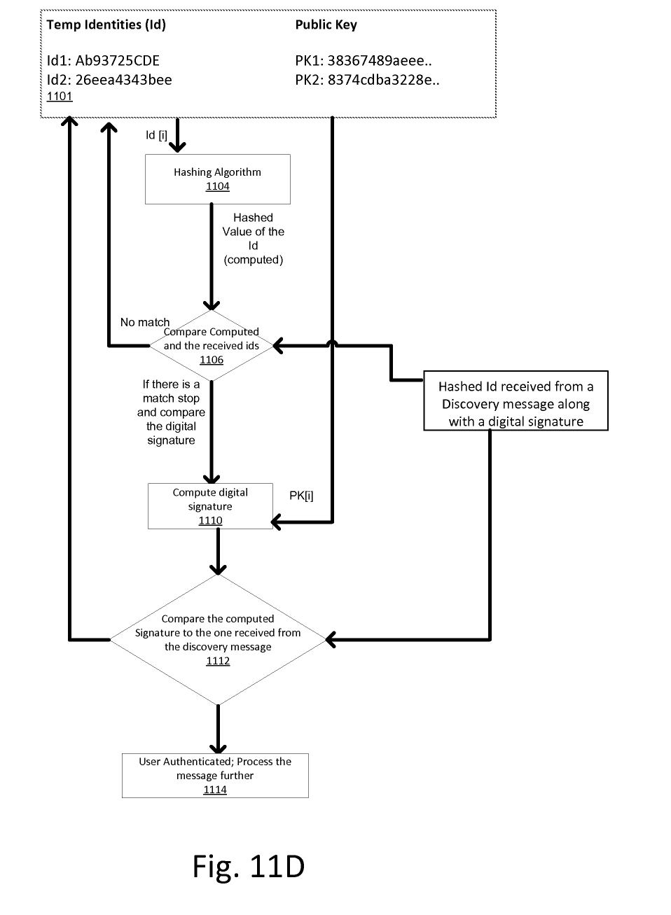

Referring to FIG. 11A, in some cases, the true identity of a user may be hidden because of privacy reasons and therefore only a temporary identity may be used. Temporary identities are the IDs that would be sent in the discovery message. Temporary identities may themselves be hashed for privacy protection and for mitigating replay attacks. A sending user (sender) that would like to be discovered by only known users (restricted discovery) may provide his or her identity beforehand to known users. Users/UEs may maintain and store a list of user identities 1102 that have been communicated for discovery purposes. For example, the list of identities 1102 that are maintained by a user may imply that the users whose identities have been listed are providing a discovery authorization to the particular user that maintains the list. When a user receives a discovery message, it may use its list of identities 1102. The user may run each one of the identities from the list of identities 1102 through a hashing algorithm 1104 to compute a hashed value of the identity. Still referring to FIG. 11A, at 1106, the computed hashed value of the identity may be compared to the hashed identity that was received in the discovery message. If there is a match, the user/UE may process the discovery message. If there is not match, the UE may retrieve another identity from the list of identities 1102 until there are not more identities to retrieve, or until there is a match.

In some cases, the list of the identities 1102 may be sorted so that a user who is more frequently communicated with or who is more frequently discovered is pushed to the top of the list, which may increase the probability that a match is obtained quickly. Such sorting may reduce the load on the UE and/or the network. This may also reduce non-malicious and malicious attacks on the network. In addition, or instead, the list may also be sorted based on location, time, date, or the like. A “most frequently visited” algorithm may be used in some embodiments.

In an example embodiment of ProSe discovery and identity management, identity information in a beacon is processed with a Mask. For example, the mask may be a scrambling sequence, a polynomial vector, a Boolean function, any appropriate key derivation algorithm, or the like. The Mask may be a function of an AppId, an Application User Id, or a combination thereof. The beacon may carry the AppId. In an example embodiment, a given UE registers with a ProSe server for a particular application and/or interest. The ProSe server provides an AppId/Mask to the UE, for example, directly or through a eNB/MME. The UE uses the AppId to generate the Mask or uses the Mask obtained directly for sending discovery beacon information to another UE. Alternatively, the beacon may be encrypted by the sender with a public key of the intended receiver, and an entity that decrypts it can identify the user. By way of another example, the beacon may be encrypted with a group public key (e.g., obtained from ProSe server or from AppId). The group public key/private key may be configured for all group members (e.g., users of Facebook) and used for discovery.

Verifying an identity received within a discovery message actually belongs to the sender of the discovery message may help ensure the integrity of the communications. A message sender may vouch for his or her authentication, and thus identity, within the discovery message. Authentication may be based on pre-shared keys, where two users may want to be discovered by only one another and no one else. Each user, in addition to providing their identities to one another, may also provide a shared secret that may be used to prove their authenticity. Referring to FIGS. 11B, a UE may store a list of identities and shared secrets 1102a. Thus, an identity and a shared secret may be provided to the hashing algorithm, as described with reference to FIG. 11A.

Referring to FIG. 11C, in some cases, authentication may be performed using pre-shared keys and may provide protection against replay attacks. A user that sends the discovery message may use various parameters 1108, along with its ID and a shared secret (see also FIG. 11B) to create a hashed ID. Example parameters include, without limitation, a system time, parameters derived from time or channel characteristics, parameters derived from a synchronization sequence (e.g., system frame number (SFN), sub-frame number), or parameters derived from synchronization information that are sent by another UE or sent by a central coordinating entity (e.g., eNB or cluster head). A user that is authorized to discover the sender's ID may then run through the hashing algorithm 1104 using each of the user identities in its list along with the associated shared secret or synchronization parameters (e.g., SFN, time-based parameters) to find a match (at 1106). If there is a match, at 1106, then the user can be assured with a higher degree of certainty that the discovery message was not replayed and that the sender is who he or she claims to be.

In a scenario in which UEs are within a cellular network, which can be referred to as a network coverage scenario or an in-coverage scenario, the network may issue a temporary identity that is to be used with the synchronization time, which may be different from the absolute time. The temporary identities and the corresponding synchronization times, which may be referred to as “ticks”, may then be used by the group members for discovery. This hybrid approach combines the randomness of the temporary identity that is pushed from the network and the capability of the terminal to use synchronized parameters (e.g., time offsets, count) for replay protection. In addition, the same network-originated message, carrying temporary identities and corresponding synchronization times (ticks), may also carry information allowing both the transmitter and the receiver to use freshness counters. Such information may set translation factors from time increments into counter increments, thus allowing a transmitter and a receiver to be synchronized on a common counter that in turn is anchored in time. For example, such information may set one counter increment to a five second time increment, allowing counter to be synchronously incremented on the transmitter side and the receiver side every five seconds. Since the information is carried in the in-coverage scenario by a secured network-originated message, it cannot be eavesdropped upon without breaking network security, and thus may provide an extra security for the discovery replay protection. The synchronization ticks may be sent by a ProSe application that the UEs share. Alternatively, the synchronization ticks may be sent by a PSSF that is trusted by the UEs or a PSSF that belongs to a single trust network.

In another embodiment, for in-coverage scenarios for example, the input to the hashing algorithm 1104 may be derived from parameters sent by the eNB (e.g., the system time or the SFN number). In yet another embodiment, for out-of-coverage scenarios for example, the input to the hashing algorithm 1104 may be derived from parameters sent by the CH. In one example method, the CH may send a synchronization sequence that provides timing for the group. The synchronization sequence may also be used by the group members to derive transmission and reception opportunities.

Referring to FIG. 11D, authentication may be based on a digital signature. For example, a UE may store a list of temporary identities and public keys 1102. In some cases, users who want to be discovered by other users may provide their public key (which may be done without the requirement of a certificate) to those other users. Alternatively, a temporary certificate that is generated on a user's behalf may be provided to the group that is authorized to receive a user's identity and communication. Referring to FIG. 11D, in accordance with the illustrated embodiment, if the computed hashed ID matched the hashed ID received in the discovery message, a digital signature is computed using one of the public keys from the list 1102. At 1112, the computed digital signature is compared to a the digital signature in the discovery message. The discovery message may contain a digital signature signed by the sender's private key. If the digital signatures match, the user is authenticated, and the message may be processed further at 1114. If the signatures do not match, the receiving UE may go through the list 1101 until the list is exhausted or until there is a match.

In another embodiment, the identity may be encrypted with a private key of the user, enabling another user who decrypts it to identify the user using the public key of the sender. Only those users who have obtained the public key either from a trusted entity, the network, or from the user/UE itself will then be able to decrypt the identity.

In another alternative embodiment, a sender's identity may be encrypted with the intended receiver's public key. A receiver may then use their private keys to decrypt the sender's identity. It is contemplated herein that the sender may choose to encrypt the sender's identity and separately encrypt other information that is then able to verify that its private key matched the decryption. The sender may then encrypt its temporary identity and concatenate it with a current time that is also encrypted using the receiver's public key. There may be just one intended recipient in accordance with an example scenario. A list of intended recipient's public keys may be used to encrypt the sender's identity. In such a list, an encrypted sender's identity may be encrypted with an intended recipient's public key.

In yet another alternative embodiment, a nonce may be encrypted with the user's private key, which may then be used to create a shared secret. Alternatively, a beacon may be encrypted with a group public key (e.g., obtained from ProSe server or from AppId). Such a group public key/private key may be configured for all group members (e.g., users of Face-book) and used only for discovery.

Users of a group may be preconfigured with an initial set of keys and a hash algorithm to refresh the keys. Such an algorithm may, for example, use time. A key table as illustrated below in Table 3 may be pre-provisioned to the users authorized for a group.

TABLE 3
Example Group Identities

| Time (T) | Shared Key |
|---|---|
| 00:00-01:00 AM | a3bcd21489f |
| 01:00-02:00 AM | 482eab242e |
| 02:00-03:00 AM | 93cb2b338a |

Referring again to FIG. 11C, the parameters 1108 used as input to the hash algorithm 1104 may include time or parameters derived from time or time-offset between cells, channel conditions or parameters derived of channel conditions, or frame number (e.g., SFN) or synchronization sequence or parameters derived therefrom. The key refresh information may include SFN number, nonce, time, group channel ID, index or similar input. Each group member may run a hash or other algorithm to obtain a current key from the initial shared key plus the key refresh material. In other embodiments, for asynchronous deployments for example, the key refresh information may include the time offset between the two cells.

A refresh or rekeying may be based on a key refresh input provided by the central entity (e.g., eNB). In some cases, the key refresh algorithm may be implicitly generated using synchronization code provided by the coordinating entity. The key refresh information may include, for example, a nonce, time, group channel ID, index, or similar input. Each group member may run a hash or specified algorithm to obtain a current key from the initial shared key plus the key refresh material.

For integrity protection, the data sent on the group channel may be appended using a message authentication code generated using a UE-specific key. The UE specific key may be generated using the ProSe temporary ID, as discussed herein.

In-coverage mechanisms may be used while the UEs are within a network coverage area, and when the UEs are no longer in-coverage, out-of-coverage mechanisms may be used. The in-coverage mechanisms may be used for syncing-up with the network or any other Trusted entity.

Group key derivation for WiFi is also contemplated herein. The above described common key (KeNB)_{PrAS} key may be used by the UEs as the master session key (MSK) so that session keys can be generated using a 4-way handshake mechanism as described by 802.11 standards. The key may be cryptographically adjusted to meet the size and nature of the MSK. It will be understood that the mechanisms described here may be applied to WiFi based Proximity Services.

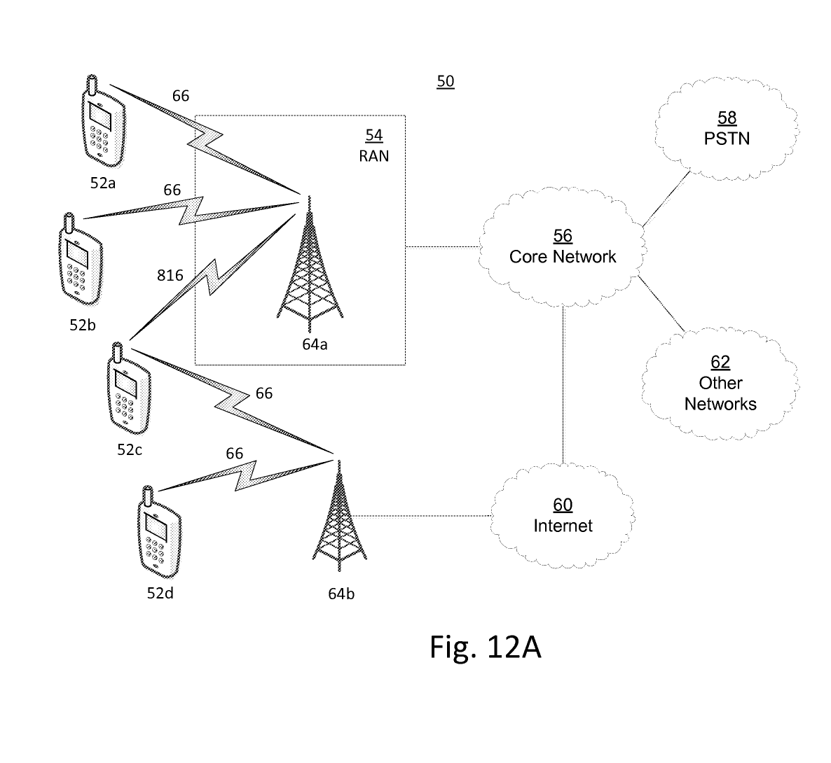

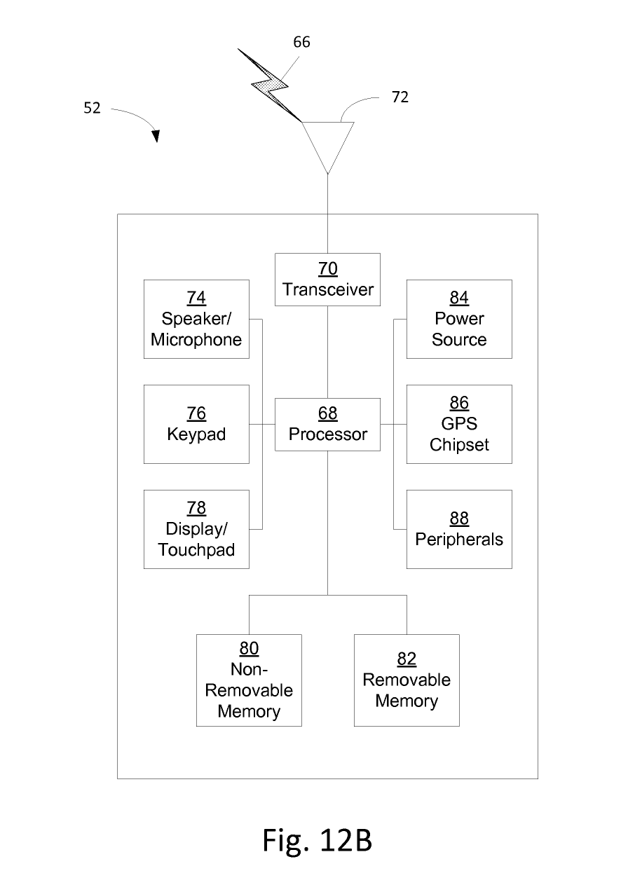

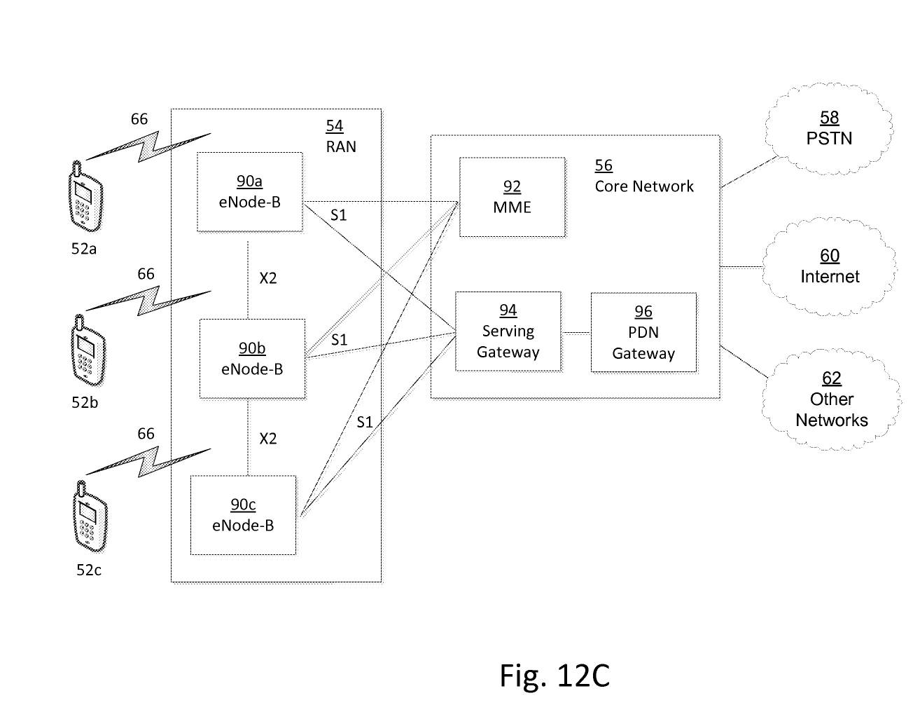

FIG. 12A is a diagram of an example communications system 50 in which one or more disclosed embodiments may be implemented. The communications system 50 may be a multiple access system that provides content, such as voice, data, video, messaging, broadcast, etc., to multiple wireless users. The communications system 50 may enable multiple wireless users to access such content through the sharing of system resources, including wireless bandwidth. For example, the communications systems 50 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 12A, the communications system 50 may include wireless transmit/receive units (WTRUs) 52a, 52b, 52c, 52d, a radio access network (RAN) 54, a core network 56, a public switched telephone network (PSTN) 58, the Internet 60, and other networks 62, though it will be appreciated that the disclosed embodiments contemplate any number of WTRUs, base stations, networks, and/or network elements. Each of the WTRUs 52a, 52b, 52c, 52d may be any type of device configured to operate and/or communicate in a wireless environment. By way of example, the WTRUs 52a, 52b, 52c, 52d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 50 may also include a base station 64a and a base station 64b. Each of the base stations 64a, 64a may be any type of device configured to wirelessly interface with at least one of the WTRUs 52a, 52b, 52c, 52d to facilitate access to one or more communication networks, such as the core network 56, the Internet 60, and/or the networks 62. By way of example, the base stations 64a, 64a may be a base transceiver station (BTS), a Node-B, an eNode B, a Home Node B, a Home eNode B, a site controller, an access point (AP), a wireless router, and the like. While the base stations 64a, 64a are each depicted as a single element, it will be appreciated that the base stations 64a, 64a may include any number of interconnected base stations and/or network elements.

The base station 64a may be part of the RAN 54, which may also include other base stations and/or network elements (not shown), such as a base station controller (BSC), a radio network controller (RNC), relay nodes, etc. The base station 64a and/or the base station 64a may be configured to transmit and/or receive wireless signals within a particular geographic region, which may be referred to as a cell (not shown). The cell may further be divided into cell sectors. For example, the cell associated with the base station 64a may be divided into three sectors. Thus, in an embodiment, the base station 64a may include three transceivers, i.e., one for each sector of the cell. In an embodiment, the base station 64a may employ multiple-input multiple output (MIMO) technology and, therefore, may utilize multiple transceivers for each sector of the cell.

The base stations 64a, 64a may communicate with one or more of the WTRUs 52a, 52b, 52c, 52d over an air interface 66, which may be any suitable wireless communication link (e.g., radio frequency (RF), microwave, infrared (IR), ultraviolet (UV), visible light, etc.). The air interface 66 may be established using any suitable radio access technology (RAT).

More specifically, as noted above, the communications system 50 may be a multiple access system and may employ one or more channel access schemes, such as CDMA, TDMA, FDMA, OFDMA, SC-FDMA, and the like. For example, the base station 64a in the RAN 54 and the WTRUs 52a, 52b, 52c may implement a radio technology such as Universal Mobile Telecommunications System (UMTS) Terrestrial Radio Access (UTRA), which may establish the air interface 66 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 64a and the WTRUs 52a, 52b, 52c may implement a radio technology such as Evolved UMTS Terrestrial Radio Access (E-UTRA), which may establish the air interface 66 using Long Term Evolution (LTE) and/or LTE-Advanced (LTE-A).

In other embodiments, the base station 64a and the WTRUs 52a, 52b, 52c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 64a in FIG. 12A may be a wireless router, Home Node B, Home eNode B, femto cell base station, or access point, for example, and may utilize any suitable RAT for facilitating wireless connectivity in a localized area, such as a place of business, a home, a vehicle, a campus, and the like. In an embodiment, the base station 64a and the WTRUs 52c, 52d may implement a radio technology such as IEEE 802.11 to establish a wireless local area network (WLAN). In an embodiment, the base station 64a and the WTRUs 52c, 52d may implement a radio technology such as IEEE 802.15 to establish a wireless personal area network (WPAN). In yet an embodiment, the base station 64a and the WTRUs 52c, 52d may utilize a cellular-based RAT (e.g., WCDMA, CDMA2000, GSM, LTE, LTE-A, etc.) to establish a picocell or femtocell. As shown in FIG. 12A, the base station 64a may have a direct connection to the Internet 60. Thus, the base station 64a may not be required to access the Internet 60 via the core network 56.

The RAN 54 may be in communication with the core network 56, which may be any type of network configured to provide voice, data, applications, and/or voice over internet protocol (VoIP) services to one or more of the WTRUs 52a, 52b, 52c, 52d. For example, the core network 56 may provide call control, billing services, mobile location-based services, pre-paid calling, Internet connectivity, video distribution, etc., and/or perform high-level security functions, such as user authentication. Although not shown in FIG. 12A, it will be appreciated that the RAN 54 and/or the core network 56 may be in direct or indirect communication with other RANs that employ the same RAT as the RAN 54 or a different RAT. For example, in addition to being connected to the RAN 54, which may be utilizing an E-UTRA radio technology, the core network 56 may also be in communication with another RAN (not shown) employing a GSM radio technology.

The core network 56 may also serve as a gateway for the WTRUs 52a, 52b, 52c, 52d to access the PSTN 58, the Internet 60, and/or other networks 62. The PSTN 58 may include circuit-switched telephone networks that provide plain old telephone service (POTS). The Internet 60 may include a global system of interconnected computer networks and devices that use common communication protocols, such as the transmission control protocol (TCP), user datagram protocol (UDP) and the internet protocol (IP) in the TCP/IP internet protocol suite. The networks 62 may include wired or wireless communications networks owned and/or operated by other service providers. For example, the networks 62 may include another core network connected to one or more RANs, which may employ the same RAT as the RAN 54 or a different RAT.

Some or all of the WTRUs 52a, 52b, 52c, 52d in the communications system 800 may include multi-mode capabilities, i.e., the WTRUs 52a, 52b, 52c, 52d may include multiple transceivers for communicating with different wireless networks over different wireless links. For example, the WTRU 52c shown in FIG. 12A may be configured to communicate with the base station 64a, which may employ a cellular-based radio technology, and with the base station 64b, which may employ an IEEE 802 radio technology.

FIG. 12B is a system diagram of an example WTRU 52. As shown in FIG. 12B, the WTRU 52 may include a processor 68, a transceiver 70, a transmit/receive element 72, a speaker/microphone 74, a keypad 76, a display/touchpad 78, non-removable memory 80, removable memory 82, a power source 84, a global positioning system (GPS) chipset 86, and other peripherals 88. It will be appreciated that the WTRU 52 may include any sub-combination of the foregoing elements while remaining consistent with an embodiment.

The processor 68 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 68 may perform signal coding, data processing, power control, input/output processing, and/or any other functionality that enables the WTRU 52 to operate in a wireless environment. The processor 68 may be coupled to the transceiver 70, which may be coupled to the transmit/receive element 72. While FIG. 12B depicts the processor 68 and the transceiver 70 as separate components, it will be appreciated that the processor 68 and the transceiver 70 may be integrated together in an electronic package or chip. The processor 68 may perform application-layer programs (e.g., browsers) and/or radio access-layer (RAN) programs and/or communications. The processor 68 may perform security operations such as authentication, security key agreement, and/or cryptographic operations, such as at the access-layer and/or application layer for example.

The transmit/receive element 72 may be configured to transmit signals to, or receive signals from, a base station (e.g., the base station 64a) over the air interface 66. For example, in an embodiment, the transmit/receive element 72 may be an antenna configured to transmit and/or receive RF signals. In an embodiment, the transmit/receive element 72 may be an emitter/detector configured to transmit and/or receive IR, UV, or visible light signals, for example. In yet an embodiment, the transmit/receive element 72 may be configured to transmit and receive both RF and light signals. It will be appreciated that the transmit/receive element 72 may be configured to transmit and/or receive any combination of wireless signals.

In addition, although the transmit/receive element 72 is depicted in FIG. 12B as a single element, the WTRU 52 may include any number of transmit/receive elements 72. More specifically, the WTRU 52 may employ MIMO technology. Thus, in an embodiment, the WTRU 52 may include two or more transmit/receive elements 72 (e.g., multiple antennas) for transmitting and receiving wireless signals over the air interface 66.

The transceiver 70 may be configured to modulate the signals that are to be transmitted by the transmit/receive element 72 and to demodulate the signals that are received by the transmit/receive element 72. As noted above, the WTRU 52 may have multi-mode capabilities. Thus, the transceiver 70 may include multiple transceivers for enabling the WTRU 52 to communicate via multiple RATs, such as UTRA and IEEE 802.11, for example.

The processor 68 of the WTRU 52 may be coupled to, and may receive user input data from, the speaker/microphone 74, the keypad 76, and/or the display/touchpad 78 (e.g., a liquid crystal display (LCD) display unit or organic light-emitting diode (OLED) display unit). The processor 68 may also output user data to the speaker/microphone 74, the keypad 76, and/or the display/touchpad 78. In addition, the processor 818 may access information from, and store data in, any type of suitable memory, such as the non-removable memory 80 and/or the removable memory 82. The non-removable memory 80 may include random-access memory (RAM), read-only memory (ROM), a hard disk, or any other type of memory storage device. The removable memory 82 may include a subscriber identity module (SIM) card, a memory stick, a secure digital (SD) memory card, and the like. In other embodiments, the processor 818 may access information from, and store data in, memory that is not physically located on the WTRU 52, such as on a server or a home computer (not shown).

The processor 68 may receive power from the power source 84, and may be configured to distribute and/or control the power to the other components in the WTRU 52. The power source 84 may be any suitable device for powering the WTRU 52. For example, the power source 84 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 68 may also be coupled to the GPS chipset 86, which may be configured to provide location information (e.g., longitude and latitude) regarding the current location of the WTRU 52. In addition to, or in lieu of, the information from the GPS chipset 86, the WTRU 52 may receive location information over the air interface 816 from a base station (e.g., base stations 64a, 64b) and/or determine its location based on the timing of the signals being received from two or more nearby base stations. It will be appreciated that the WTRU 52 may acquire location information by way of any suitable location-determination method while remaining consistent with an embodiment.

The processor 68 may further be coupled to other peripherals 88, which may include one or more software and/or hardware modules that provide additional features, functionality and/or wired or wireless connectivity. For example, the peripherals 88 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 12C is a system diagram of the RAN 54 and the core network 806 according to an embodiment. As noted above, the RAN 54 may employ a UTRA radio technology to communicate with the WTRUs 52a, 52b, 52c over the air interface 66. The RAN 54 may also be in communication with the core network 806. As shown in FIG. 12C, the RAN 54 may include Node-Bs 90a, 90b, 90c, which may each include one or more transceivers for communicating with the WTRUs 52a, 52b, 52c over the air interface 66. The Node-Bs 90a, 90b, 90c may each be associated with a particular cell (not shown) within the RAN 54. The RAN 54 may also include RNCs 92a, 92b. It will be appreciated that the RAN 54 may include any number of Node-Bs and RNCs while remaining consistent with an embodiment.

As shown in FIG. 12C, the Node-Bs 90a, 90b may be in communication with the RNC 92a. Additionally, the Node-B 90c may be in communication with the RNC 92b. The Node-Bs 90a, 90b, 90c may communicate with the respective RNCs 92a, 92b via an Iub interface. The RNCs 92a, 92b may be in communication with one another via an Iur interface. Each of the RNCs 92a, 92b may be configured to control the respective Node-Bs 90a, 90b, 90c to which it is connected. In addition, each of the RNCs 92a, 92b may be configured to carry out and/or support other functionality, such as outer loop power control, load control, admission control, packet scheduling, handover control, macrodiversity, security functions, data encryption, and the like.

The core network 56 shown in FIG. 12C may include a media gateway (MGW) 844, a mobile switching center (MSC) 96, a serving GPRS support node (SGSN) 98, and/or a gateway GPRS support node (GGSN) 99. While each of the foregoing elements are depicted as part of the core network 56, it will be appreciated that any one of these elements may be owned and/or operated by an entity other than the core network operator.

The RNC 92a in the RAN 54 may be connected to the MSC 96 in the core network 56 via an IuCS interface. The MSC 96 may be connected to the MGW 94. The MSC 96 and the MGW 94 may provide the WTRUs 52a, 52b, 52c with access to circuit-switched networks, such as the PSTN 58, to facilitate communications between the WTRUs 52a, 52b, 52c and traditional land-line communications devices.

The RNC 92a in the RAN 54 may also be connected to the SGSN 98 in the core network 806 via an IuPS interface. The SGSN 98 may be connected to the GGSN 99. The SGSN 98 and the GGSN 99 may provide the WTRUs 52a, 52b, 52c with access to packet-switched networks, such as the Internet 60, to facilitate communications between and the WTRUs 52a, 52b, 52c and IP-enabled devices.

As noted above, the core network 56 may also be connected to the networks 62, which may include other wired or wireless networks that are owned and/or operated by other service providers.

Although features and elements are described above in particular combinations, each feature or element can be used alone or in any combination with the other features and elements. Additionally, the embodiments described herein are provided for exemplary purposes only. Furthermore, the embodiments described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for securing proximity communication between a first user equipment (UE) and a second UE, wherein each UE has a pre-established security association with a network entity, the method comprising:
obtaining a first key associated with the pre-established security association between the first UE and the network entity;
obtaining a second key associated with the pre-established security association between the second UE and the network entity;
receiving a notification indicating that the first UE and the second UE desire to engage in proximity communications; and
deriving, based on the first key and the second key, first and second intermediate keys that can be used by the first UE and second UE, respectively, to derive a common shared key for securing proximity communications between the first UE and the second UE.

2. The method as recited in claim 1, the method further comprising transmitting the first intermediate key to the first UE and transmitting the second intermediate key to the second UE.

3. The method as recited in claim 1, wherein the method is performed by a proximity services security function that resides on an eNodeB or a mobile management entity.

4. The method as recited in claim 1, wherein the pre-established security association between the first UE and the network entity is a radio-level security association between the first UE and an eNodeB or mobile management entity (MME).

5. The method as recited in claim 1, the method further comprising:
generating a nonce;
applying a function on the nonce and the first key to derive the first intermediate key; and
applying the function on the nonce and the second key to derive the second intermediate key.

6. The method as recited in claim 5, the method further comprising:
encrypting the second intermediate key with the first intermediate key, resulting in an encrypted second intermediate key; and
sending the nonce and the encrypted second intermediate key to the first UE.

7. The method as recited in claim 5, the method further comprising:
encrypting the first intermediate key with the second intermediate key, resulting in an encrypted first intermediate key; and
sending the nonce and the encrypted first intermediate key to the first second.

8. The method as recited in claim 1, the method further comprising:
deriving, based on the first and second intermediate keys, the common shared key.

9. The method as recited in claim 1, wherein the network entity is at least one of an eNodeB or a mobile management entity (MME).

10. The method as recited in claim 1, wherein the notification indicating that the first UE and the second UE desire to engage in proximity communications is received from one of the first UE and the second UE.

11. The method as recited in claim 1, wherein the first UE and the second UE belong to a group that includes one or more UEs in addition to the first UE and the second UE, the common shared key being a group key for communicating within the group.

12. The method as recited in claim 11, wherein the group key is used to decrypt a message by one of the UEs belonging to the group after a digital signature of the message is verified, wherein the digital signature is specific to an originator of the message.

13. The method as recited in claim 11, wherein one of the UEs that belong to the group is a cluster head that is trusted by each of the UEs in the group, and wherein the method is performed by a proximity services security function that resides on the cluster head.

14. The method as recited in claim 11, the method further comprising:
receiving a request from a new UE to join the group;
obtaining a new key associated with the pre-established security association between the new UE and the network entity;
receiving a notification indicating that the first UE and the second UE desire to engage in proximity communications; and
deriving, based on the new key, a new intermediate key that can be used by the group of UEs to derive a new common shared key for securing proximity communications between the UEs in the group.

15. The method as recited in claim 1, wherein the pre-established security association between the first UE and the network entity is a security association between the first UE and a private key generator.

16. The method as recited in claim 15, wherein the private key generator provisions the first UE with a public identity, the public identity being the first key.

17. A network entity in a communication network, the network entity having a pre-established security association with each of a first user equipment (UE) and a second UE, the network entity comprising:
a memory comprising executable instructions; and
a processor that, when executing the executable instructions, effectuates operations comprising:
obtaining a first key associated with the pre-established security association between the first UE and the network entity;
obtaining a second key associated with the pre-established security association between the second UE and the network entity;
receiving a notification indicating that the first UE and the second UE desire to engage in proximity communications; and
deriving, based on the first key and the second key, first and second intermediate keys that can be used by the first UE and second UE, respectively, to derive a common shared key for securing proximity communications between the first UE and the second UE.

18. The network entity as recited in claim 17, wherein the processor further effectuates operations comprising:
transmitting the first intermediate key to the first UE and transmitting the second intermediate key to the second UE.

19. The network entity as recited in claim 17, wherein the processor further effectuates operations comprising:
generating a nonce;
applying a function on the nonce and the first key to derive the first intermediate key; and
applying the function on the nonce and the second key to derive the second intermediate key.

20. The network entity as recited in claim 19, wherein the processor further effectuates operations comprising:
encrypting the second intermediate key with the first intermediate key, resulting in an encrypted second intermediate key; and
sending the nonce and the encrypted second intermediate key to the first UE.

21. The network entity as recited in claim 19, wherein the processor further effectuates operations comprising:
encrypting the first intermediate key with the second intermediate key, resulting in an encrypted first intermediate key; and
sending the nonce and the encrypted first intermediate key to the first second.
